(19) United States
(12) Patent Application Publication
(10) Pub. No.: US 2013/0108807 A1
(43) Pub. Date: May 2, 2013

(54) TWISTED-ALIGNMENT-MODE LIQUID CRYSTAL DISPLAY

(71) Applicant: FUJIFILM CORPORATION, Tokyo (JP)

(72) Inventors: Hiroshi SATO, Kanagawa (JP); Jun TAKEDA, Kanagawa (JP)

(73) Assignee: FUJIFILM CORPORATION, Tokyo (JP)

(21) Appl. No.: 13/712,415

(22) Filed: Dec. 12, 2012

Related U.S. Application Data
(63) Continuation-in-part of application No. PCT/JP2011/064044, filed on Jun. 20, 2011.

(30) Foreign Application Priority Data
Jun. 21, 2010 (JP) 2010-140455

(51) Int. Cl. C09K 19/00

(52) U.S. Cl. CPC C09K 19/00
USPC 428/1.33

(57) ABSTRACT

Provided is twisted-alignment-mode liquid crystal display wherein frame-like light leakage can be reduced. The twisted-alignment-mode liquid crystal display comprises a pair of polarizers disposed so that the polarization axes are orthogonal to each other; a twisted-alignment-mode liquid crystal cell disposed between the polarizers; and a low-substitution layer comprising cellulose acylate satisfying 2.0<Z1<2.7 as a main component, where Z1 represents the total degree of substitution of acyl groups of the cellulose acylate in the low-substitution layer.

The present application is a continuation of PCT/JP2011/64044 filed on Jun. 20, 2011 and claims priority under 35 U.S.C. §119 of Japanese Patent Application No. 140455/2010, filed on Jun. 21, 2010.

### BACKGROUND OF THE INVENTION

1. Field of the Invention

The present invention relates to a twisted-alignment-mode liquid crystal display.

2. Background Art

A twisted alignment mode such as a twisted nematic (TN) mode is generally used as a drive mode of a liquid crystal display, in which an electric field is applied between upper and lower substrates to induce rising of liquid crystal molecules for driving the liquid crystal display. A TN-mode liquid crystal display includes, for example, a cellulose acetate film as a protective film to protect a polarizer. The total thickness of a liquid crystal display is recently required to be reduced in response to a strong demand for a thinner display. This results in a decrease in a distance between a liquid crystal panel unit and a backlight unit, causing distortion of an optical film due to heat from a backlight. As a result, retardation occurs at ends of a liquid crystal display, leading to frame-like light leakage during black display. In a proposed means to solve the above-described problem, a photoelastic coefficient of an adhesive layer, which is used for preparing a polarizing plate, is adjusted within a predetermined range, for example, as disclosed in JP-A-2006-91254 and JP-A-2006-208465.

In another proposed means, cellulose acylate having a low degree of substitution of acyl groups is used as a material for a protective film of a polarizing plate used in a liquid crystal display, for example, as disclosed in JP-A-2009-265598.

### SUMMARY OF THE INVENTION

An object of the present invention, which has been made in light of the problem, is to reduce frame-like light leakage during black display by a twisted-alignment-mode liquid crystal display.

Means for solving the above-described problem are as follows:

[1] A twisted-alignment-mode liquid crystal display comprising:

a pair of polarizers disposed such that the polarization axes are orthogonal to each other;

a twisted-alignment-mode liquid crystal cell disposed between the polarizers; and

a low-substitution layer comprising cellulose acylate satisfying Formula (1) as a main component,

2.0<Z1<2.7, (1)

where Z1 represents the total degree of substitution of acyl groups of the cellulose acylate in the low-substitution layer.
[2] The liquid crystal display according to [1], wherein the low-substitution layers are each disposed between the pair of polarizers and the twisted-alignment-mode liquid crystal cell.
[3] The liquid crystal display according to [2], wherein the low-substitution layer has a retardation in-plane Re (550) of −50 to 150 nm and a retardation along the thickness direction Rth (550) of −50 to 200 nm at a wavelength of 550 nm.
[4] The liquid crystal display according to any one of [1] to [3], wherein the low-substitution layers are each provided on an outer surface of each of the pair of polarizers.
[5] The liquid crystal display according to [1],

wherein the low-substitution layers are each disposed on an outer surface of each of the pair of polarizers, and are not disposed between each of the pair of polarizers and the twisted-alignment-mode liquid crystal cell, and

the liquid crystal display comprises optically anisotropic layers between each of the pair of polarizers and the twisted-alignment-mode liquid crystal cell, the optically anisotropic layers comprising liquid crystal compounds which are fixed to be in a state of hybrid alignment.
[6] The liquid crystal display according to any one of [1] to [5], wherein the low-substitution layer has a thickness of 30 to 80 μm.
[7] The liquid crystal display according to any one of [1] to [6], wherein the low-substitution layer further comprises a non-phosphate ester compound.
[8] The liquid crystal display according to any one of [1] to [7], which comprises a high-substitution layer disposed on at least one surface of the low-substitution layers, and the high-substitution layer comprising cellulose acylate satisfying Formula (2) as a main component,

2.7≦Z2, (2)

where Z2 represents the total degree of substitution of acyl groups of the cellulose acylate in the high-substitution layer.
[9] The liquid crystal display according to [8], wherein the low-substitution layer and the high-substitution layer are laminated by co-casting.
[10] The liquid crystal display according to [8] or [9], wherein the high-substitution layer comprises a non-phosphate ester compound as an additive, and

a proportion (parts by mass) of the additive to the cellulose acylate contained in the high-substitution layer is smaller than a proportion (parts by mass) of the additive to the cellulose acylate contained in the low-substitution layer.

[11] The liquid crystal display according to any one of [7] to [10], wherein the non-phosphate ester compound is a polyester compound having an aromatic ring.
[12] The liquid crystal display according to any one of [1] to [11], wherein the cellulose acylate contained in the low-substitution layer satisfies Formulas (3) to (5):

1.0<X1<2.7, Formula (3):

0≦Y1<1.5, Formula (4):

X1+Y1=Z1, Formula (5):

where X1 represents the degree of substitution of acetyl groups of the cellulose acylate in the low-substitution layer, Y1 represents the total degree of substitution of acyl groups having three or more carbon atoms of the cellulose acylate in the low-substitution layer, and Z1 represents the total degree of substitution of acyl groups of the cellulose acylate in the low-substitution layer.
[13] The liquid crystal display according to any one of [8] to [12], wherein the cellulose acylate contained in the high-substitution layer satisfies Formulas (6) to (8):

1.2<X2<3.0, Formula (6):

0≦Y2<1.5, Formula (7):

X2+Y2=Z2, Formula (8):

where X2 represents the degree of substitution of acetyl groups of the cellulose acylate in the high-substitution layer, Y2 represents the total degree of substitution of acyl groups having three or more carbon atoms of the cellulose acylate in the high-substitution layer, and Z2 represents the total degree of substitution of acyl groups of the cellulose acylate in the high-substitution layer.
[14] The liquid crystal display according to any one of [1] to [13], wherein the acyl groups of the cellulose acylate contained in the low-substitution layer and/or the high-substitution layer has a carbon number of 2 to 4.
[15] The liquid crystal display according to any one of [1] to [14], wherein the cellulose acylate contained in the low-substitution layer and/or the high-substitution layer is cellulose acetate.
[16] The liquid crystal display according to any one of [1] to [15], which comprises a film on an outer surface of at least one of the pair of polarizers, the film comprising at least one selected from cyclic olefin resin, polyolefin resin, polyester resin, polycarbonate resin, acrylate rein, and cellulose acylate resin.

According to the present invention, frame-like light leakage, which occurs during black display by a twisted-alignment-mode liquid crystal display, can be reduced.

### BRIEF DESCRIPTION OF THE DRAWINGS

FIG. 1 is a schematic sectional view of an exemplary liquid crystal display of the present invention.

FIG. 2 is a schematic view illustrating exemplary, simultaneous co-casting of a three-layered film of cellulose acylate having a low degree of substitution with a co-casting die.

### DETAILED DESCRIPTION OF THE INVENTION

The invention is described in detail hereinunder. Note that, in this patent specification, any numerical expressions in a style of “ . . . to . . . ” will be used to indicate a range including the lower and upper limits represented by the numerals given before and after “to”, respectively.

In this description, Re(λ) and Rth(λ) are retardation (nm) in-plane and retardation (nm) along the thickness direction, respectively, at a wavelength of λ. Re(λ) is measured by applying light having a wavelength of λ nm to a film in the normal direction of the film, using KOBRA 21ADH or WR (by Oji Scientific Instruments). The selection of the measurement wavelength may be conducted according to the manual-exchange of the wavelength-selective-filter or according to the exchange of the measurement value by the program.

When a film to be analyzed is expressed by a monoaxial or biaxial index ellipsoid, Rth(λ) of the film is calculated as follows.

Rth(λ) is calculated by KOBRA 21ADH or WR on the basis of the six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in-plane), a value of hypothetical mean refractive index, and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to formulae (A) and (III):

$$Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos ( {sin}^{- 1} ( \frac{sin ( - θ )}{nx} ) )} \qquad ( A )$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

Rth={(nx+ny)/2−nz}×d (III):

In the formula, nx represents a refractive index in the in-plane slow axis direction; ny represents a refractive index in the in-plane direction perpendicular to nx; and nz represents a refractive index in the direction perpendicular to nx and ny. And “d” is a thickness of the film.

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below:

cellulose acylate (1.48), cycloolefin polymer (1.52), polycarbonate (1.59), polymethylmethacrylate (1.49) and polystyrene (1.59). KOBRA 21ADH or WR calculates nx, ny and nz, upon enter of the hypothetical values of these mean refractive indices and the film thickness. On the basis of thus-calculated nx, ny and nz, Nz=(nx−nz)/(nx−ny) is further calculated.

The term “slow axis” refers to a direction of a maximum refractive index. In addition, the refractive index is measured at a wavelength in a visible light region (λ: 550 nm) unless otherwise specified.

Throughout this specification, the numerical values indicating optical characteristics of components such as an optical film and a liquid crystal layer, the ranges of the numerical values, and the qualitative expressions, for example, “equivalent” and “equal”, indicate numerical values, the ranges of the numerical values, and properties, respectively, which include errors that are generally allowable in liquid crystal displays and components used therein.

The present invention relates to a twisted-alignment-mode liquid crystal display having a low-substitution layer containing cellulose acylate having a low degree of substitution, which satisfies predetermined conditions, as a main component. Through various investigations, the inventor has been discovered that a low-substitution layer containing cellulose acylate having a low degree of substitution, which satisfies predetermined conditions, as a main component can achieve optical characteristics required for a protective film of a polarizing plate despite its small thickness compared with a typical layer containing cellulose acylate having a high degree of substitution as a main component. The twisted-alignment-mode liquid crystal display of the invention includes the low-substitution layer; hence, the thickness of a liquid crystal panel unit can be reduced compared with a current unit. As a result, distortion of a liquid crystal panel or a polarizing plate due to, for example, heat can be reduced, resulting in a reduction in frame-like light leakage occurring during black display.

To achieve the effects of the invention, the thickness of the low-substitution layer is adequately 80 μm or less, preferably 70 μm or less, and more preferably 60 μm or less. The lower limit of the thickness is unlimited but is preferably 30 μm in general.

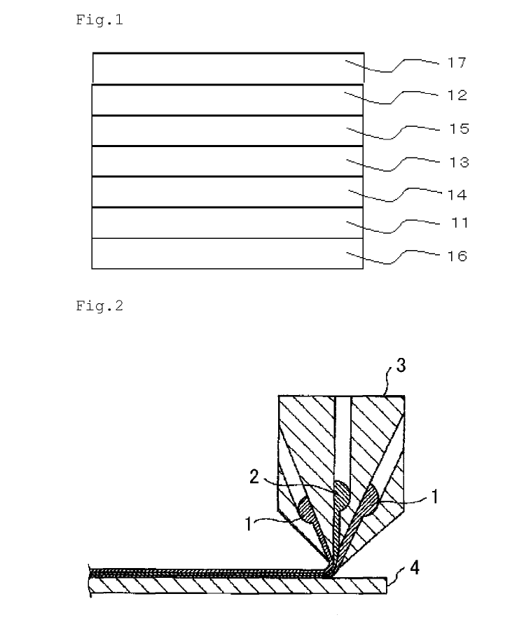

FIG. 1 is a schematic sectional view of an exemplary liquid crystal display of the present invention. The liquid crystal display includes a pair of polarizers 11 and 12, and a TN-mode liquid crystal cell 13 disposed between the polarizers. Inner protective films 14 and 15 are disposed between the liquid crystal cell 13 and the polarizer 11 and between the liquid crystal cell 13 and the polarizer 12, respectively. The polarizers 11 and 12 are disposed with their polarization axes orthogonal to each other. The liquid crystal cell 13 is of a TN-mode, i.e., is driven through rising of liquid crystal molecules. The inner surface of an undepicted cell substrate is rubbed in orthogonal directions. Outer protective films 16 and 17 composed of a polymer such as cellulose acylate are disposed on the respective outer sides of the polarizers 11 and 12.

The same effects are provided regardless of whether a display surface exists on an upper or lower side in the drawing.

In an embodiment of the invention, the inner protective films 14 and 15 are each composed of a low-substitution layer containing the cellulose acylate satisfying Formula (1) as a main component.

2.0<Z1<2.7, (1)

where Z1 represents the total degree of substitution of acyl groups of the cellulose acylate in the low-substitution layer.

In this embodiment, the inner protective films 14 and 15 preferably exhibit the same optical characteristics. In addition, the inner protective films 14 and 15 in the embodiment may or may not contribute to optical compensation of the TN-mode liquid crystal cell. In an exemplary case of the former embodiment, each of the inner protective films 14 and 15 is preferably biaxial and has an Re (550) of 10 to 150 nm and an Rth (550) of 60 to 200 nm. In an exemplary case of the latter embodiment, the inner protective films each have an Re (550) of −50 to 10 nm and an Rth (550) of −50 to 60 nm.

In the embodiment, any protective film can be used as the outer protective films 14 and 15. For example, a triacetylcellulose (TAC) film, which has been generally used as a protective film of a polarizing plate, may be used. Commercially available products may also be used.

In another embodiment of the invention, the inner protective films 14 and 15 and the outer protective films 16 and 17 are each composed of the predetermined low-substitution layer. In such an embodiment, the inner protective films 14 and 15 preferably exhibit the same optical characteristics.

In the embodiment, the inner protective films 14 and 15 may or may not contribute to the optical compensation of the TN-mode liquid crystal cell. In an exemplary case of the former embodiment, each of the inner protective films 14 and 15 is preferably biaxial and has an Re (550) of 10 to 150 nm and an Rth (550) of 60 to 200 nm. In an exemplary case of the latter embodiment, the inner protective films each have an Re (550) of −50 to 10 nm and an Rth (550) of −50 to 60 nm. In the embodiment, if the inner protective films 14 and 15 each have an in-plane slow axis, the in-plane slow axis is preferably disposed parallel or orthogonal to the absorption axis of the polarizer.

In the embodiment, the outer protective films 16 and 17 do not contribute to optical compensation of the TN-mode liquid crystal cell, and may have any optical characteristics without limitation. For example, the outer protective films each have an Re (550) of −50 to 200 nm and an Rth (550) of −50 to 200 nm.

In another embodiment of the invention, the outer protective films 16 and 17 are each composed of the predetermined low-substitution layer, and neither the inner protective film 14 or 15 does not include the low-substitution layer. Neither the outer protective film 16 or 17 does not contribute to optical compensation of the TN-mode liquid crystal cell, and may have any optical characteristics without limitation. For example, the outer protective films each have an Re (550) of −50 to 200 nm and an Rth (550) of −50 to 200 nm.

In the embodiment, the inner protective films 14 and 15 may or may not contribute to optical compensation of the TN-mode liquid crystal cell. In an exemplary case of the former embodiment, the inner protective films 14 and 15 are each an optically compensatory film including a support composed of a polymer film, and an optically anisotropic layer provided on the support, the optically anisotropic layer containing a liquid crystal compound fixed to hybrid alignment. The outer protective films 16 and 17 are each composed of the predetermined, low-substitution layer, which provides the advantageous effects of the invention, i.e., a reduction in frame-like light leakage. In addition, the inner protective films 14 and 15 are each the predetermined optically compensatory film, thereby the viewing angle characteristics can be improved. The optically compensatory film is described in detail later.

In any one of the above-described embodiments, the low-substitution layer may be integrated with another layer to configure an outer or inner protective film of the polarizer. For example, a high substitution layer containing cellulose acylate, which satisfies Formula (2), as a main component may be laminated on one or two surfaces of the low-substitution layer so that such a laminate is used as the outer or inner protective film.

2.7≦Z2, (2)

where Z2 represents the total degree of substitution of acyl groups of the cellulose acylate in the high-substitution layer.

In an embodiment where the high-substitution layer is used as the inner protective films 14 and 15, the high-substitution layer is disposed on a surface side of a belt to facilitate separation of the film from the belt surface during film formation, which is advantageous in production stability. In addition, the high-substitution layer is preferably has a small thickness, specifically 10 μm or less, compared with the low-substitution layer in order to prevent the effect of the invention from being impaired. The low-substitution layer and the high-substitution layer are preferably laminated with co-casting.

Various components usable in the twisted-alignment-mode liquid crystal display of the invention are now described.

### Low-Substitution Layer:

The twisted-alignment-mode liquid crystal display of the invention includes a low-substitution layer containing the cellulose acylate satisfying Formula (1) as a main component.

2.0<Z1<2.7, (1)

where Z1 represents the total degree of substitution of acyl groups of the cellulose acylate in the low-substitution layer.

In this specification, “a component contained as a main component” refers to the relevant component in an embodiment where only one component exists as a material, and refers to a component having the highest mass fraction in an embodiment where two or more components exist as materials.

As described above, the high-substitution layer may have a high-substitution layer on at least one surface thereof, the high-substitution layer containing the cellulose acylate satisfying Formula (2) as a main component.

2.7≦Z2, (2)

where Z2 represents the total degree of substitution of acyl groups of the cellulose acylate in the high-substitution layer.

### (Cellulose Acylate)

The cellulose acylate to be used for preparing the low-substitution layer and high-substitution layer includes cotton linter, wood pulp (hardwood pulp, softwood pulp), etc.; and any cellulose acylate resin starting from any type of cellulose is usable herein, and as the case may be, plural types of cellulose acylate resins may be mixed for use here. The starting cellulose is described in detail, for example, in Marusawa & Uda's “Plastic Material Course (17), Cellulose Resin” by Nikkan Kogyo Shinbun (issued 1970), and Hatsumei Kyokai Disclosure Bulletin No. 2001-1745 (pp. 7-8); and various types of cellulose disclosed in these are usable here with no specific limitation thereon for use for the cellulose acylate film in the invention.

The starting cellulose acylate to be used for preparing the low-substitution layer and high-substitution layer may have one type of acyl group or plural types of acyl groups. The cellulose acylate having one or more C₂₋₄ acyl groups are preferable. If the cellulose acylate having plural types of acyl groups is used, one of the acyl group is preferably an acetyl. As the C₂₋₄ acyl group, propionyl or butyryl is preferable. The cellulose acylates having such an acyl group may exhibit a good solubility, and a suitable solution to be used for preparing the film may be prepared by dissolving the cellulose acylates having such an acyl group in a solvent especially such as non-chlorine based solvent. Furthermore, the solution having a low viscosity and good-filtration property may be prepared.

A cellulose has free hydroxyl groups at 2-position, 3-position and 6-position per a unit of glucose having a β-1,4 bonding. Cellulose acylates are polymers obtained by acylation for apart or all of these hydroxyls. The degree of acyl-substitution means the total ratios of acylation for each of the 2-, 3- and 6-position-hydroxyls in a cellulose molecule. The degree of acyl-substitution is 1 when the ratio of acylation for each of the 2-, 3- and 6-position-hydroxyls is 100%.

Examples of the C₂ or longer acyl group include an aliphatic acyl group and an aryl acyl group. Examples of the cellulose acylate include alkyl carbonyl esters, alkenyl carbonyl esters, aromatic carbonyl esters, and aromatic alkyl carbonyl esters of cellulose, and they may have at least one substituent. Preferable examples of the acyl group include acetyl, propionyl, butanoyl, heptanoyl, hexanoyl, octanoyl, decanoyl, dodecanoyl, tridecanoyl, tetradecanoyl, hexadecanoyl, octadecanoyl, isobutanoyl, tert-butanoyl, cyclohexane carbonyl, oleoyl, benzoyl, naphthyl carbonyl, and cinnamoyl. Among these, acetyl, propionyl, butanoyl, dodecanoyl, octadecanoyl, tert-butanoyl, oleoyl, benzoyl, naphthyl carbonyl, and cinnamoyl are more preferable; acetyl, propionyl and butanoyl, each of which is C₂₋₄ acyl group, are even more preferable; and acetyl is especially preferable, or that is, cellulose acetate is especially preferable as the cellulose acylate.

In acylation of cellulose, when an acid anhydride or an acid chloride is used as the acylating agent, the organic solvent as the reaction solvent may be an organic acid, such as acetic acid, or methylene chloride or the like.

When the acylating agent is an acid anhydride, the catalyst is preferably a protic catalyst such as sulfuric acid; and when the acylating agent is an acid chloride (e.g., CH₃CH₂COCl), a basic compound may be used as the catalyst.

A most popular industrial production method for a mixed fatty acid ester of cellulose comprises acylating cellulose with a fatty acid corresponding to an acetyl group and other acyl groups (e.g., acetic acid, propionic acid, valeric acid, etc.), or with a mixed organic acid ingredient containing their acid anhydride.

According to the invention, the cellulose acylate to be used in preparing the low-substitution layer preferably fulfills the conditions of formulas (3) and (4) in terms of the wavelength dispersion characteristics of retardation.

1.0<X1<2.7, (3)

In formula (3), X1 represents a degree of acetylation of the cellulose acylate used as the main ingredient of the layer with low degree of total acyl substitution.

0≦Y1<1.5, (4)

In formula (4), Y1 represents a degree of acyl-substitution having 3 or more carbon atoms of the cellulose acylate used as the main ingredient of the layer with low degree of total acyl substitution.

It is to be noted that X1 and Y1 along with Z1 in formula (1) described above fulfill the condition of “X1+Y1=Z1”.

According to the invention, the cellulose acylate to be used in preparing the high-substitution layer preferably fulfills the conditions of formulas (5) and (6) in terms of the wavelength dispersion characteristics of retardation.

1.2<X2<3.0 (5)

In formula (5), X2 represents a degree of acetylation of the cellulose acylate used as the main ingredient of the outermost layer with high degree of total acyl substitution.

0≦Y2<1.5 (6)

In formula (6), Y2 represents a degree of acyl-substitution having 3 or more carbon atoms of the cellulose acylate used as the main ingredient of the outermost layer with high degree of total acyl substitution.

It is to be noted that X2 and Y2 along with Z2 in formula (2) described above fulfill the condition of “X2+Y2=Z2”.

The cellulose esters which can be used in the invention may be prepared according to the method described in JP-A-10-45804 or the like.

### (Non-Phosphate Ester Compound)

The low-substitution layer preferably contains at least one non-phosphate ester compound in the layer with low degree of total acyl substitution (more preferably in both of the high-substitution layer). By adding such a non-phosphate ester compound, the film exhibiting low haze can be prepared.

In the specification, the term “non-phosphate ester compound” is used for any ester compounds in which the acid contributing to the ester bond is other than phosphoric acid, or, that is, the term “non-phosphate compound” means any ester compound not containing phosphoric acid.

The non-phosphate ester compound may be selected from low-molecular weight compounds or high-molecular weight compounds (polymers). The non-phosphate ester compound selected from polymers is occasionally referred to as “non-phosphate ester type polymer” hereinunder.

Preferably, in terms of lowering haze, the high-substitution layer contains at least one non-phosphate ester compound, and the ratio (the part by mass) of the non-phosphate ester compound in the high-substitution layer is smaller than the ratio (the part by mass) of the non-phosphate ester compound in the low-substitution layer. Next, the non-phosphate ester compound which can be used in the invention will be described in detail.

The non-phosphate ester compound may be selected from the high-molecular weight additives or the low-molecular weight additives. An amount of the additive with respect to the cellulose acylate is preferably from 1 to 35% by mass, more preferably from 4 to 30% by mass, or even more preferably from 10 to 25% by mass.

The high-molecular weight additive which can be used as the non-phosphate ester compound in the cellulose acylate film is preferably selected from the polymers having a number-averaged molecular weight of from 700 to 10000. The polymer additive may have a function contributing to accelerating the volatilization rate of the solvent and lowering the content of the residual solvent in the solution casting method. The polymer additive may be effective in terms of improvement of the film properties such as the mechanical properties, the flexibility, the anti-water absorbability, and the anti-moisture permeability.

The number-averaged molecular weight of the polymer additive, which can be used as the non-phosphate ester compound, is preferably from 700 to 8000, more preferably from 700 to 5000, and even more preferably from 1000 to 5000.

Examples of the polymer additive, which can be used as the non-phosphate ester compound, include, but are not limited, those described in detail below. The non-phosphate ester compound is preferably selected from ester compounds other than phosphate.

Examples of the high-molecular-weight-additive, which is a non-phosphate compound, include polyester-type polymers such as aliphatic polyester-type polymers and aromatic polyester-type polymers, and any copolymers of polyester component(s) and other component(s); and preferable examples thereof include aliphatic polyester-type polymers, aromatic polyester-type polymers, copolymers of polyester-type polymers (e.g. aliphatic polyester-type polymers and aromatic polyester-type polymers) and acryl-type polymers, and copolymers of polyester-type polymers (e.g. aliphatic polyester-type polymers and aromatic polyester-type polymers) and styrene-type polymers. The copolymers in which at least one polyester component has an aromatic ring are more preferable.

The polyester-type polymers, which can be used in the invention, may be produced by reaction of a mixture of an aliphatic dicarboxylic acid having from 2 to 20 carbon atoms, and a diol selected from the group consisting of aliphatic diols having from 2 to 12 carbon atoms and alkyl ether diols having from 4 to 20 carbon atoms, and both ends of the reaction product may be as such, or may be blocked by further reaction with a monocarboxylic acid, a monoalcohol or a phenol. The terminal blocking may be effected for the reason that the absence of a free carboxylic acid in the polymer is effective for the storability thereof. The dicarboxylic acid for the polyester-type polymer is preferably a C₄₋₂₀ aliphatic dicarboxylic residue or a C₈₋₂₀ aromatic dicarboxylic residue.

The aliphatic dicarboxylic acids having from 2 to 20 carbon atoms preferably for use in the invention include, for example, oxalic acid, malonic acid, succinic acid, maleic acid, fumaric acid, glutaric acid, adipic acid, pimelic acid, suberic acid, azelaic acid, sebacic acid, dodecanedicarboxylic acid and 1,4-cyclohexanedicarboxylic acid.

More preferred aliphatic dicarboxylic acids in these are malonic acid, succinic acid, maleic acid, fumaric acid, glutaric acid, adipic acid, azelaic acid, 1,4-cyclohexanedicarboxylic acid. Particularly preferred dicarboxylic acids are succinic acid, glutaric acid and adipic acid.

The diol used for the high-molecular-weight additive may be selected from aliphatic diols having from 2 to 20 carbon atoms and alkyl ether diols having from 4 to 20 carbon atoms.

Examples of the aliphatic diol having from 2 to 20 carbon atoms include alkyldiols and aliphatic diols, and more specifically include ethandiol, 1,2-propandiol, 1,3-propandiol, 1,2-butandiol, 1,3-butandiol, 2-methyl-1,3-propandiol, 1,4-butandiol, 1,5-pentandiol, 2,2-dimethyl-1,3-propandiol(neopentyl glycol), 2,2-diethyl-1,3-propandiol(3,3-dimethylolpentane), 2-n-buthyl-2-ethyl-1,3-propandiol(3,3-dimethylolheptane), 3-methyl-1,5-pentandiol, 1,6-hexandiol, 2,2,4-trimethyl-1,3-pentandiol, 2-ethyl-1,3-hexandiol, 2-methyl-1,8-octandiol, 1,9-nonandiol, 1,10-decandiol, 1,12-octadecandiol, etc. One or more of these glycols may be used either singly or as any mixture.

Preferable examples of the aliphatic diol include an ethandiol, 1,2-propandiol, 1,3-propandiol, 1,2-butandiol, 1,3-butandiol, 2-methyl-1,3-propandiol, 1,4-butandiol, 1,5-pentandiol, 3-methyl-1,5-pentandiol, 1,6-hexandiol, 1,4-cyclohexandiol, and 1,4-cyclohexandimethanol. Particularly preferred examples include ethandiol, 1,2-propandiol, 1,3-propandiol, 1,2-butandiol, 1,3-butandiol, 1,4-butandiol, 1,5-pentandiol, 1,6-hexandiol, 1,4-cyclohexandiol, and 1,4-cyclohexanedimethanol.

Preferable examples of the alkyl ether diol having from 4 to 20 carbon atoms include polytetramethylene ether glycol, polyethylene ether glycol and polypropylene ether glycol, and any combinations thereof. The average degree of polymerization is preferably, but not limited, from 2 to 20, more preferably 2 to 10, further preferably from 2 to 5, especially preferably from 2 to 4. Examples of the commercially-available typical polyether glycol include Carbowax resin, Pluronics resin and Niax resin.

Especially preferred is a high-molecular-weight additive of which the terminal is blocked with an alkyl group or an aromatic group. The terminal protection with a hydrophobic functional group is effective against aging at high temperature and high humidity, by which the hydrolysis of the ester group is delayed.

Preferably, the polyester additive is protected with a monoalcohol residue or a monocarboxylic acid residue in order that both ends of the polyester additive are not a carboxylic acid or a hydroxyl group.

In this case, the monoalcohol is preferably selected from substituted or unsubstituted monoalcohols having from 1 to 30 carbon atoms, including aliphatic alcohols such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodecaoctanol, allyl alcohol, and oleyl alcohol; and substituted alcohols such as benzyl alcohol, and 3-phenylpropanol.

Examples of the alcohol, which is preferably used for terminal blocking, include methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol, and benzyl alcohol; and methanol, ethanol, propanol, isobutanol, cyclohexyl alcohol, 2-ethylhexyl alcohol, isononyl alcohol, and benzyl alcohol are preferable.

The monocarboxylic acid for use as the monocarboxylic acid residue in terminal blocking is preferably selected from substituted or non-substituted monocarboxylic acid having from 1 to 30 carbon atoms. It may be an aliphatic monocarboxylic acid or an aromatic monocarboxylic acid. Preferable examples of the aliphatic monocarboxylic acids include acetic acid, propionic acid, butanoic acid, caprylic acid, caproic acid, decanoic acid, dodecanoic acid, stearic acid, and oleic acid. Examples of the aromatic monocarboxylic acids include benzoic acid, p-tert-butylbenzoic acid, orthotoluic acid, metatoluic acid, paratoluic acid, dimethylbenzoic acid, ethylbenzoic acid, normal-propylbenzoic acid, aminobenzoic acid, and acetoxybenzoic acid. One or more of these may be used either singly or as combination thereof.

The polymer additive may be easily produced according to any of a thermal melt condensation method of polyesterification or interesterification of the dicarboxylic acid and diol and/or monocarboxylic acid or monoalcohol for terminal blocking, or according to an interfacial condensation method of an acid chloride of those acids and a glycol in an ordinary manner. The polyester additives are described in detail in “Additives, Their Theory and Application” (by Miyuki Publishing, first original edition published on Mar. 1, 1973, edited by Koichi Murai). The materials described in JP-A 05-155809, 05-155810, 05-197073, 2006-259494, 07-330670, 2006-342227, 2007-003679 are also usable in the invention.

The aromatic polyester-type polymers may be prepared by carrying out copolymerization of polyester polymer(s) and any monomer(s) having an aromatic group. The monomer having an aromatic group may be one or more selected from C₈₋₂₀ aromatic dicarboxylic acids and C₆₋₂₀ aromatic diols. Examples of the C₈₋₂₀ aromatic dicarboxylic acids include phthalic acid, terephthalic acid, isophthalic acid, 1,5-naphthalene dicarboxylic acid, 1,4-naphthalene dicarboxylic acid, 1,8-naphthalene dicarboxylic acid, 2,8-naphthalene dicarboxylic acid and 2,6-naphthalene dicarboxylic acid. Among these, preferable examples are phthalic acid, terephthalic acid and isophthalic acid.

Examples of the C₆₋₂₀ aromatic diol include, but are not limited, bisphenol A, 1,2-hydroxy benzene, 1,3-hydroxy benzene, 1,4-hydroxy benzene and 1,4-benzene dimethanol; and preferable are bisphenol A, 1,4-hydroxy benzene and 1,4-benzene dimethanol.

The aromatic polyester-type polymer may be any combinations of the above-described polyester(s) and at least one aromatic dicarboxylic acid or at least one aromatic diol, and any combinations containing two or more types of ingredients are usable. As described above, the polymer additives of which ends are blocked with an alkyl group or aromatic group are especially preferable. The method for blocking the ends may be carried out according to the above-described method.

### <Other Additives>

At least one additive other than the non-phosphate ester compound may be added to the low-substitution layer and high-substitution layer, and examples of the additive include retardation controllers (e.g. retardation enhancers and retardation reducers), plasticizers such as phthalates and phosphates, UV absorbers, antioxidants and matting agents.

According to the invention, the retardation reducer may be selected from any phosphoric acid type ester compounds or any known additives as an additive for a cellulose acylate film other than the non-phosphate ester compound.

The polymer retardation reducer is preferably selected from phosphate-polyester type polymers, styrene-type polymers, acryl-type polymers and any combinations thereof, and more preferably selected from acryl-type polymers and styrene-type polymers. At least one of the polymer retardation reducer is preferably selected from negative intrinsic birefringent polymers such as styrene-type and acryl-type polymers.

Examples of the compound other than the non-phosphate ester compound which can be used as the low-molecular weight retardation reducer include, but are not limited to, those described below. The low-molecular weight retardation reducer may be selected from solid or oily compounds. Namely, the low-molecular weight retardation reducer to be used in the invention is not limited in terms of the melting or boiling point. The mixture of UV absorbers having the melting point of not greater than 20 degrees Celsius and greater than 20 degrees Celsius respectively may be used, as well as the mixture of anti-degradation agents. Examples of the infrared absorber dye include those described in JP-A-2001-194522. The additive may be added to a cellulose acylate solution (dope) anytime in preparing the solution. Adding the additive to the cellulose acylate solution may be carried out as the final step in the preparation of the solution. An amount of each additive is not limited so far as obtaining its function.

Examples of the low-molecular weight retardation reducer other than non-phosphate ester compound include, but are not limited, those described in JP-A-2007-272177, [0066]-[0085].

The compounds, which are described in JP-A-2007-272177, [0066]-[0085], may be prepared according to the method described below.

The compound represented by formula (1) described in JP-A-2007-272177 may be prepared by a condensation reaction of a sulfonyl chloride derivative and an amine derivative.

The compound represented by formula (2) described in JP-A-2007-272177 may be prepared by a dehydration-condensation reaction of a carboxylic acid and an amine using a condensation agent such as dicyclohexylcarbodiimide (DCC), or by a substitution reaction of a carbonyl chloride derivative and an amine derivative.

Examples of the retardation reducer include Rth reducers. Among the above-described retardation reducers, acryl-type polymers, styrene-type polymers, and low-molecular weight compounds of formulas (3)-(7), described in JP-A-2007-272177, can be used as an Rth reducer. Among these, acryl-type and styrene-type polymers are preferable, and acryl-type polymers are more preferable.

An amount of the retardation reducer with respect to the cellulose acylate is preferably from 0.01 to 30% by mass, more preferably from 0.1 to 20% by mass, or even more preferably from 0.1 to 10% by mass.

When the amount is not greater than 30% by mass, it is possible to improve the compatibility with the cellulose acylate and to prevent from getting cloudy. When plural retardation reducers are used, a total amount thereof preferably falls within the above-described range.

### (Plasticizer)

Any compounds which have been known as a plasticizer in cellulose acylate may be used in the invention. Examples of the plasticizer include phosphate esters and carboxylate esters. Examples of the phosphates include triphenyl phosphate (TPP) and tricresyl phosphate (TCP). The carboxylates are typically phthalates and citrates. Examples of the phthalates include dimethyl phthalate (DMP), diethyl phthalate (DEP), dibutyl phthalate (DBP), dioctyl phthalate (DOP), diphenyl phthalate (DPP) and diethylhexyl phthalate (DEHP). Examples of the citrates include triethyl O-acetyl citrate (OACTE) and tributyl O-acetylcitrate (OACTB). Examples of other carboxylates include butyl oleate, methylacetyl ricinoleate, dibutyl sebacate, various trimellitates, etc. The phthalate-type plasticizers (DMP, DEP, DBP, DOP, DPP, DEHP) are preferably used here. DEP and DPP are especially preferred.

### (Retardation Developer)

The low-substitution cellulose acylate film preferably contains at least one retardation developer in the low-substitution layer in order to develop a retardation value. Examples of the retardation developer include, but not limited to, rod or disc compounds, and compounds having a retardation developing function among the above-described non-phosphorylated ester compounds. In the rod or discotic compounds, a compound having at least two aromatic rings can be preferably used as the retardation developer.

The proportion of the retardation developer composed of the rod compound is preferably 0.1 to 30 parts by mass, and more preferably 0.5 to 20 parts by mass with respect to 100 parts by mass of a polymer component containing the cellulose acylate. The content of the disc compound in the retardation developer is preferably less than 3 parts by mass, more preferably less than 2 parts by mass, and most preferably less than 1 part by mass with respect to 100 parts by mass of the cellulose acylate.

The discotic compound has an excellent Rth retardation developing function compared with the rod compound, and is preferably used if a particularly large Rth retardation is required. Two or more retardation developers may be used in combination.

The retardation developer preferably has maximal absorption in a wavelength range of 250 to 400 nm while having substantially no absorption in a visible region.

The discotic compound is now described. A compound having at least two aromatic rings can be used as the discotic compound.

In this specification, “aromatic ring” includes an aromatic hetero ring in addition to an aromatic hydrocarbon ring.

The aromatic hydrocarbon ring is preferably six-membered rings (benzene rings).

The aromatic hetero ring is commonly an unsaturated hetero ring. The aromatic hetero ring is preferably a five-, six-, or seven-membered ring, and more preferably a five- or six-membered ring. The aromatic hetero ring commonly has its maximum double bonds. Preferred heteroatoms include nitrogen, oxygen, and sulfur atoms, among which a nitrogen atom is particularly preferred. Examples of the aromatic hetero ring include a furan ring, a thiophene ring, a pyrrole ring, oxazole rings, an isoxazole ring, a triazole ring, an isothiazole ring, an imidazole ring, a pyrazole ring, a furazan ring, a triazole ring, a pyran ring, a pyridine ring, a pyridazine ring, a pyrimidine ring, a pyrazine ring, and a 1,3,5-triazine ring.

Preferred aromatic ring includes a benzene ring, a condensed benzene ring, and biphenyls. In particular, 1,3,5-triazine ring is preferably used. Specifically, for example, the compounds disclosed in JP-A-2001-166144 are preferably used.

The number of carbon atoms of the aromatic rings of the retardation developer ranges preferably from 2 to 20, more preferably from 2 to 12, further preferably from 2 to 8, and most preferably from 2 to 6.

A bonding state between the two aromatic rings includes (a) formation of a condensed ring, (b) direct bonding through a single bond, and (c) bonding through a linking group (spiro linkage is not allowed due to the aromatic rings). The two aromatic rings may be bonded together through any of the bonding modes (a) to (c).

Examples of the condensed ring (a) (a condensed ring of two or more aromatic rings) include an indene ring, a naphthalene ring, an azulene ring, a fluorene ring, a phenanthrene ring, an anthracene ring, an acenaphthylene ring, a biphenylene ring, a naphthacene ring, a pyrene ring, an indole ring, an isoindole ring, a benzofuran ring, a benzothiophene ring, an indolizine ring, a benzoxazole ring, a benzothiazole ring, a benzimidazole ring, a benzotriazole ring, a purine ring, an indazole ring, a chromene ring, a quinoline ring, an isoquinoline ring, a quinolizine ring, a quinazoline ring, a cinnoline ring, a quinoxaline ring, a phthalazine ring, a pteridine ring, a carbazole ring, an acridine ring, a phenanthridine ring, a xanthene ring, a phenazine ring, a phenothiazine ring, a phenoxathiin ring, a phenoxazine ring, and a thianthrene ring. In particular, the naphthalene ring, azulene ring, indole ring, benzoxazole ring, benzothiazole ring, benzimidazole ring, benzotriazole ring, and quinoline ring are preferred.

The single bond (b) is preferably a bond between the carbon atoms of two aromatic rings. Two aromatic rings may be bonded through two or more single bonds to form an aliphatic ring or a nonaromatic heterocycle between the two aromatic rings.

The linking group (c) is also preferably bonded to the carbon atoms of two aromatic rings. The linking group is preferably an alkylene group, an alkenylene group, an alkynylene group, —CO—, —O—, —NH—, —S—, or a combination thereof. Examples of the linking group combination are shown below. In the exemplary linking group combination, the order of the linking groups may be reversed.

c1: —CO—O—

c2: —CO—NH—

c3: -alkylene-O—

c4: —NH—CO—NH—

c5: —NH—CO—O—

c6: —O—CO—O—

c7: —O-alkylene-O—

c8: —CO-alkenylene-

c9: —CO-alkenylene-NH—

c10: —CO-alkenylene-O—

c11: -alkylene-CO—O-alkylene-O—CO-alkylene-

c12: —O-alkylene-CO—O-alkylene-O—CO-alkylene-O—

c13: —O—CO-alkylene-CO—O—

c14: —NH—CO-alkenylene-

c15: —O—CO-alkylene-

The aromatic ring and the linking group may each have a substituent.

Examples of the substituent include halogen atoms (F, Cl, Br, and I), a hydroxyl group, a carboxyl group, a cyano group, an amino group, a nitro group, a sulfo group, a carbamoyl group, a sulfamoyl group, an ureido group, an alkyl group, an alkenyl group, an alkynyl group, an aliphatic acyl group, an aliphatic acyloxy group, an alkoxy group, an alkoxycarbonyl group, an alkoxycarbonylamino group, an alkylthio group, an alkylsulfonyl group, an aliphatic amide group, an aliphatic sulfonamide group, an aliphatic substituted amino group, an aliphatic substituted carbamoyl group, an aliphatic substituted sulfamoyl group, an aliphatic substituted ureido group, and a nonaromatic heterocyclic group.

The alkyl group preferably has 1 to 8 carbon atoms. A chain allyl group is preferred compared with a cyclic allyl group, and a linear chain alkyl group is particularly preferred. The alkyl group may further have a substituent, for example, a hydroxy group, a carboxy group, an alkoxy group, and an alkyl-substituted amino group. Examples of the alkyl group (including a substituted alkyl group) include a methyl group, an ethyl group, an n-butyl group, an n-hexyl group, 2-hydroxyethyl group, 4-carbxybutyl group, 2-methoxyethyl group, and 2-diethylaminoethyl group.

The alkenyl group preferably has 2 to 8 carbon atoms. A chain alkenyl group is preferred compared with a cyclic alkenyl group, and a linear chain alkenyl group is particularly preferred. The alkenyl group may further have a substituent. Examples of the alkenyl groups include a vinyl group, an allyl group, and a 1-hexenyl group.

The alkynyl group preferably has 2 to 8 carbon atoms. A chain alkynyl group is preferred compared with a cyclic alkynyl group, and a linear chain alkynyl group is particularly preferred. The alkynyl group may further have a substituent. Examples of the alkynyl group include an ethynyl group, a 1-butynyl group, and a 1-hexynyl group.

The aliphatic acyl group preferably has 1 to 10 carbon atoms. Examples of the aliphatic acyl group include an acetyl group, a propanoyl group, and a butanoyl group.

The aliphatic acyloxy group preferably has 1 to 10 carbon atoms. Examples of the aliphatic acyloxy group include an acetoxy group.

The alkoxy group preferably has 1 to 8 carbon atoms. The alkoxy group may further have a substituent (for example, an alkoxy group). Examples of the alkoxy group (including substituted alkoxy group) include a methoxy group, an ethoxy group, a butoxy group, and a methoxyethoxy group.

The alkoxycarbonyl group preferably has 2 to 10 carbon atoms. Examples of the alkoxycarbonyl groups include a methoxycarbonyl group and an ethoxycarbonyl group.

The alkoxycarbonylamino group preferably has 2 to 10 carbon atoms. Examples of the alkoxycarbonylamino groups include a methoxycarbonylamino group and an ethoxycarbonylamino group.

The alkylthio group preferably has 1 to 12 carbon atoms. Examples of the alkylthio group include a methylthio group, an ethylthio group, and an octylthio group.

The alkylsulfonyl group preferably has 1 to 8 carbon atoms. Examples of the alkylsulfonyl groups include a methanesulfonyl group and an ethanesulfonyl group.

The aliphatic amide group preferably has 1 to 10 carbon atoms. Examples of the aliphatic amide group include acetamide.

The aliphatic sulfonamide group preferably has 1 to 8 carbon atoms. Examples of the aliphatic sulfonamide group include a methanesulfonamide group, a butanesulfonamide group, and an n-octanesulfonamide group.

The aliphatic substituted amino group preferably has 1 to 10 carbon atoms. Examples of the aliphatic substituted amino group include a dimethylamino group, a diethylamino group, and a 2-carboxyethylamino group.

The aliphatic substituted carbamoyl group preferably has 2 to 10 carbon atoms. Examples of the aliphatic substituted carbamoyl group include a methylcarbamoyl group and a diethylcarbamoyl group.

The aliphatic substituted sulfamoyl group preferably has 1 to 8 carbon atoms. Examples of the aliphatic substituted sulfamoyl group include a methylsulfamoyl group and a diethylsulfamoyl group.

The aliphatic substituted ureido group preferably has 2 to 10 carbon atoms. Examples of the aliphatic substituted ureido group include a methylureido group.

Examples of the nonaromatic heterocyclic group include a piperidino group and a morpholino group.

The molecular weight of the retardation developer preferably ranges from 300 to 800.

A triazine compound represented by formula (I) is preferably used as a discotic compound.

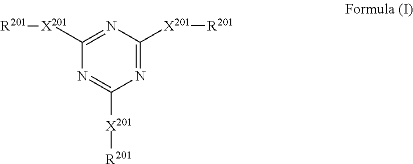

In formula (I), R²⁰¹'s each independently represent an aromatic ring or a heterocycle having at least one substituent at ortho, meta, and/or para position. X²⁰¹'s each independently represent a single bond or —NR²⁰²—. R²⁰², s each independently represent a hydrogen atom, a substituted or non-substituted alkyl group, an alkenyl group, an aryl group, or a heterocyclic group.

The aromatic ring represented by R²⁰¹ is preferably phenyl or naphthyl, and phenyl is particularly preferred. The aromatic ring represented by R²⁰¹ may have at least one substituent at substitution sites. Examples of the substituent include halogen atoms, a hydroxyl group, a cyano group, a nitro group, a carboxyl group, alkyl groups, alkenyl groups, aryl groups, alkoxy groups, alkenyloxy groups, aryloxy groups, acyloxy groups, alkoxycarbonyl groups, alkenyloxycarbonyl groups, aryloxycarbonyl groups, a sulfamoyl group alkyl-substituted sulfamoyl groups, alkenyl-substituted sulfamoyl groups, aryl-substituted sulfamoyl groups, a sulfonamide group, a carbamoyl group, alkyl-substituted carbamoyl groups, alkenyl-substituted carbamoyl groups, aryl-substituted carbamoyl groups, an amide group, alkylthio groups, alkenylthio groups, arylthio groups, and acyl groups.

The heterocyclic group represented by R²⁰¹ is preferably aromatic. The aromatic heterocycle is commonly an unsaturated hetero ring, and preferably has its maximum double bonds. The heterocyclic group is preferably a five-, six-, or seven-membered ring, more preferably a five- or six-membered ring, and most preferably a six-membered ring. The hetero atom of the heterocycle is preferably a nitrogen, sulfur, or oxygen atom, and a nitrogen atom is particularly preferred. A particularly preferred aromatic heterocycle is a pyridine ring (preferred heterocyclic groups are 2-pyridyl and 4-pyridyl groups). The heterocyclic group may have a substituent. Examples of the substituent for the heterocyclic group are the same as those of the substituent for the aryls described above.

If X²⁰¹ is a single bond, the heterocyclic group preferably has a nitrogen atom having a free valency. The heterocyclic group with a nitrogen atom having a free valency is preferably a five-, six-, or seven-membered ring, more preferably a five- or six-membered ring, and most preferably a five-membered ring. The heterocyclic group may also have a plurality of nitrogen atoms. In addition, the heterocyclic group may have a hetero atom (for example, O or S) other than the nitrogen atom. Examples of the heterocyclic group with a nitrogen atom having a free valency are shown below. In the examples, —C₄H₉ⁿ represents n-C₄H₉.

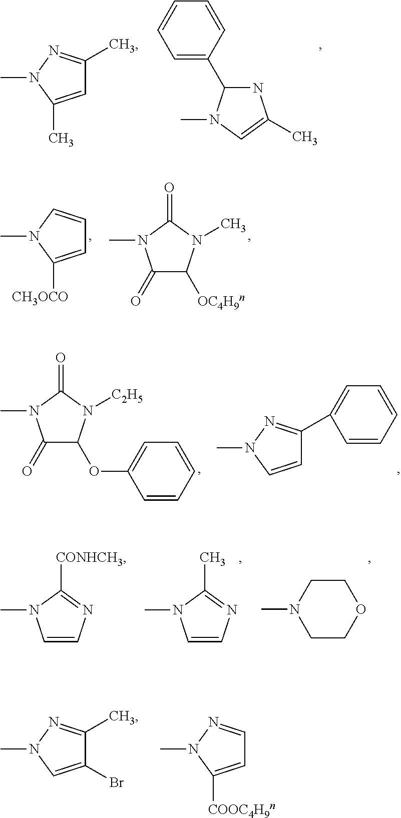

The alkyl group represented by R²⁰² is preferably a chain alkyl group though it may be a cyclic alkyl group, and is more preferably a linear chain alkyl group rather than a branched chain alkyl group. The number of carbon atoms of the alkyl group ranges preferably from 1 to 30, more preferably from 1 to 20, further preferably from 1 to 10, further preferably from 1 to 8, and most preferably from 1 to 6. The alkyl group may have a substituent. Examples of the substituent include halogen atoms, alkoxy groups (for example, a methoxy group and an ethoxy group), and acyloxy groups (for example, an acryloyloxy group and a methacryloyloxy group).

The alkenyl group represented by R²⁰² is preferably a chain alkenyl group though it may be a cyclic alkenyl group, and is more preferably a linear chain alkenyl group rather than a branched chain alkenyl group. The number of carbon atoms of the alkenyl group ranges preferably from 2 to 30, more preferably from 2 to 20, further preferably from 2 to 10, further preferably from 2 to 8, and most preferably from 2 to 6. The alkenyl group may have a substituent. Examples of the substituent are the same as those of the substituent for the alkyl group.

The aromatic ring group and the heterocyclic group represented by R²⁰² and their preferred ranges are similar to those of the aromatic ring and the heterocycle represented by R²⁰¹ and their preferred ranges, respectively. The aromatic ring group and the heterocyclic group may each further have a substituent. Examples of the substituent are the same as those of the substituent for each of the aromatic ring and the heterocycle represented by R²⁰¹.

The compounds represented by General formula (I) can be synthesized by any known method, for example, described in JP-A-2003-344655. The retardation developer is described in detail in Hatsumeikyoukai Kokaigiho (Journal of Technical Disclosure), Kogi No. 2001-1745, p. 49.

Retardation developers usable in the invention may be polymeric additives other than the low molecular weight compounds. The non-phosphate ester polymers used in the invention may also function as retardation developers. Preferred examples of the polymeric retardation developers that also function as non-phosphate ester polymers include the aromatic polyester polymers described above and copolymers of the aromatic polyester polymers with other resins.

The retardation developers in the invention are more preferably Re developers from the viewpoint of effective development of Re to achieve an appropriate Nz factor. Among the retardation developers, examples of the Re developer include disc compounds and rod compounds.

In the invention, anti-degradation agents, ultraviolet absorbers, releasing agents, mat agents, lubricants, and plasticizers can be appropriately used if necessary.

### (Anti-Degradation Agent)

At least one anti-degradation (antioxidant) agent may be added to the low-substitution layer and high-substitution layer, and examples thereof include phenol-type and hydroquinone-type antioxidant agents such as 2,6-di-tert-butyl-4-methylphenol, 4,4′-thiobis-(6-tert-butyl-3-methylphenol), 1,1′-bis(4-hydroxyphenyl)cyclohexane, 2,2′-methylenebis(4-ethyl-6-tert-butylphenol) 2,5-di-tert-butylhydroquinone, and pentaerythrityl tetrakis[3-(3,5-di-tert-butyl-4-hydroxyphenyl)propionate]. Also preferred are phosphonic acid-type antioxidants such as tris(4-methoxy-3,5-diphenyl)phosphite, tris(nonylphenyl)phosphite, tris(2,4-di-tert-butylphenyl)phosphite, bis(2,6-di-tert-butyl-4-methylphenyl)pentaerythritol diphosphite and bis(2,4-di-tert-butylphenyl)pentaerythritol diphosphite. An amount of the anti-degradation agent to be added may be from 0.05 to 5.0 parts by mass relative to 100 parts by mass of the cellulose acylate.

### (UV Absorber)

The low-substitution layer and high-substitution layer may contain at least one UV absorber. The UV absorber is preferably selected from UV absorbers excellent in absorption ability for light having a wavelength of not longer than 370 nm, and having little absorption of light having a wavelength of not shorter than 400 nm, in terms of the good displaying characteristics. Preferred examples of the UV absorber for use in the invention include hindered phenol compounds, hydroxybenzophenone compounds, benzotriazole compounds, salicylate compounds, benzophenone compounds, cyanoacrylate compounds, and nickel complex compounds. Examples of the hindered phenol compound include 2,6-di-tert-butyl-p-cresol, pentaerythrityl tetrakis[3-(3,5-di-tert-butyl-4-hydroxyphenyl)propionate], N,N′-hexamethylenebis(3,5-di-tert-butyl-4-hydroxy-hydrocinn amide), 1,3,5-trimethyl-2,4,6-tris(3,5-di-tert-butyl-4-hydroxybenzyl)benzene, and tris-(3,5-di-tert-butyl-4-hydroxybenzyl)isocyanurate. Examples of the benzotriazole compound include 2-(2′-hydroxy-5′-methylphenyl)benzotriazole, 2,2-methylenebis(4-(1,1,3,3-tetramethylbutyl)-6-(2H-benzotriazol-2-yl)phenol), (2,4-bis(n-octylthio)-6-(4-hydroxy-3,5-di-tert-butylanilino)-1,3,5-triazine, triethylene glycol-bis[3-(3-tert-butyl-5-methyl-4-hydroxyphenyl)propionate], N,N′-hexamethylenebis(3,5-di-tert-butyl-4-hydroxy-hydrocinn amide), 1,3,5-trimethyl-2,4,6-tris(3,5-di-tert-butyl-4-hydroxybenzyl)benzene, 2-(2′-hydroxy-3′,5′-di-tert-butylphenyl)-5-chlorobenzotriazole, 2-(2′-hydroxy-3′,5′-di-tert-amylphenyl)-5-chlorobenzotriazole, 2,6-di-tert-butyl-p-cresol, and pentaerythrityl tetrakis[3-(3,5-di-tert-butyl-4-hydroxyphenyl)propionate]. An amount of the UV absorbent to be added is preferably from 1 ppm to 1.0%, more preferably from 10 to 1000 ppm with respect to the total mass in the entire cellulose acylate laminate film.

### (Peeling Promoter)

Preferably, the low-substitution layer and high-substitution layer may contain a peeling promoter. The peeling promoter may be added to the film for the purpose of improving the peeling ability so as to be carried out more stably or more readily. The peeling promoter may be in the film, for example, in a ratio of from 0.001 to 1% by mass. Preferably, the content is at most 0.5% by mass since the releasing agent hardly separates from the film; and also preferably, the content is at least 0.005% by mass since a required release reduction effect may be realized. Accordingly, preferably, the content is from 0.005 to 0.5% by mass, more preferably from 0.01 to 0.3% by mass. The peeling promoter may be selected from any known peeling promoters such as organic and inorganic acid compounds, surfactants, and chelating agents. Above all, polycarboxylic acids and their esters are used effectively; and ethyl esters of citric acid are used more effectively.

In an embodiment where the low-substitution layer is laminated on the high-substitution layer, the high-substitution layer is preferably disposed on a surface side of a support such as a belt, and the peeling promoter is preferably added into the high-substitution layer.

### (Matting Agent)

In the high-substitution layer, at least one high-substitution layer preferably contains a matting agent from the view point of lubricity of the film and stable production. The matting agent may be selected from inorganic compounds or organic compounds.

Preferred examples of the inorganic matting agent include silicon-containing inorganic compounds such as silicon dioxide, calcined calcium silicate, hydrated calcium silicate, aluminium silicate and magnesium silicate, titanium oxide, zinc oxide, aluminium oxide, barium oxide, zirconium oxide, strontium oxide, antimony oxide, tin oxide, tin-antimony oxide, calcium carbonate, talc, clay, calcined kaolin, and calcium phosphate. More preferred are silicon-containing inorganic compounds and zirconium oxide. Particularly preferred is silicon dioxide since it can reduce haze of cellulose acylate films. As fine particles of silicon dioxide, commercially-available productions can be used, including, for example, AEROSIL R972, R972V, R974, R812, 200, 200V, 300, R202, OX50 and TT600 (all of them are manufactured by NIPPON AEROSIL CO., LTD.). As fine particles of zirconium oxide, for example, those in the market under trade names of AEROSIL R976 and R811 (manufactured by NIPPON AEROSIL CO., LTD.) can be used.

Preferable examples of the organic matting agent include polymers such as silicone resins, fluororesins, and acrylic resins. Above all, more preferred are silicone resins. Of silicone resins, even more preferred are those having a three-dimensional network structure. For example, usable are commercially-available products of Tospearl 103, Tospearl 105, Tospearl 18, Tospearl 120, Tospearl 145, Tospearl 3120 and Tospearl 240 (all trade names by Toshiba Silicone), etc.

The matting agent may be added to a cellulose acylate solution according to any method so far as desired cellulose acylate solution can be obtained without any problems. For example, the additive may be added in the stage where a cellulose acylate is mixed with a solvent; or the additive may be added to a mixture solution prepared from a cellulose acylate and a solvent. Further, the additive may be added to and mixed with a dope just before the dope is cast, and this is a so-called imminent addition method, in which the ingredients may be on-line mixed by screw kneading. Concretely, preferred is a static mixer such as an in-line mixer. As the in-line mixer, for example, preferred is a static mixer, SWJ (A static tubular mixer, Hi-Mixer, by Toray Engineering). Regarding the mode of in-line addition, JP-A 2003-053752 describes an invention of a method for producing a cellulose acylate film wherein, for the purpose of preventing concentration unevenness and particle aggregation, the distance L between the nozzle tip through which an additive liquid having a composition differing from that of the main material dope and the start end of an in-line mixer is controlled to be at most 5 times the inner diameter d of the main material feeding line, thereby preventing concentration unevenness and aggregation of matting particles, etc. JP-A 2003-053752 discloses a more preferable embodiment, in which the distance (L) between the nozzle tip opening through which an additive liquid having a composition differing from that of the main material dope and the start end of the in-line mixer is controlled to be at most 10 times the inner diameter (d) of the feeding nozzle tip opening, and the in-line mixer is a static non-stirring tubular mixer or a dynamic stirring tubular mixer. More concretely, JP-A 2003-053752 discloses that the flow ratio of the cellulose acylate film main material dope/in-line additive liquid is from 10/1 to 500/1, more preferably from 50/1 to 200/1. JP-A 2003-014933 discloses an invention of providing a retardation film which is free from a trouble of additive bleeding and a trouble of interlayer peeling and which has good lubricity and excellent transparency; and regarding the method of adding additives to the film, the patent reference says that the additive may be added to a dissolving tank, or the additive or a solution or dispersion of the additive may be added to the dope being fed in the process from the dissolving tank to a co-casting die, further describing that in the latter case, mixing means such as a static mixer is preferably provided for the purpose of enhancing the mixing efficiency therein.

In the embodiment, the laminate of the low-substitution layer and high-substitution layer has the low-substitution layer as a core layer, and the high-substitution layer disposed on each of the surfaces of the low-substitution layer; more preferably, at least one of the high-substitution layer contains the matting agent, in terms of improving the abrasion-resistant properties caused by reducing the friction coefficient of the film surface, or in terms of preventing the wide-long film from straining or cracking while being wound-up; or even more preferably, both of the high-substitution layers contain the matting agent, in terms of improving the abrasion-resistance, or in terms of preventing the straining.

The matting agent does not increase the haze of the film so far as a large amount of the agent is not added to the film. When the film containing a suitable amount of a matting agent is actually used in LCD, the film may not suffer from disadvantages such as the low contrast and the bright spots. Not too small amount of the matting agent in the film may achieve the prevention of the cracking and the improvement of the abrasion-resistance. From these viewpoints, an amount of the matting agent is preferably from 0.01 to 5.0% by mass, more preferably from 0.03 to 3.0% by mass, even more preferably from 0.05 to 1.0% by mass.

### (Haze)

The low-substitution layer or the laminate of the low-substitution layer and high-substitution layer preferably has a haze of less than 0.20%, more preferably less than 0.15%, particularly preferably less than 0.10%. Having a haze of less than 0.20%, the film can improve contrast ratio of a liquid crystal display device incorporating it and the transparency of the film is enough high to use as an optical film.

In a preferable embodiment, the high-substitution layer disposed on at least one of the surfaces of the low-substitution layer. A single type of the cellulose acylate having the uniform degree of the acylation or plural types of the cellulose acylates having the different degrees of the acylation may be contained in each of the layers. Preferably, the degree of the acylation of the cellulose acylate contained in each of the layers is uniform, in terms of adjusting the optical properties.

In case where the cellulose acylate film is produced according to a solution casting method, preferably, the layer in contact with the support (hereinafter this may be referred to as a skin B layer) is the high-substitution layer and the other layer is the low-substitution layer, from the viewpoint of improving the releasability of the film from the support in the solution casting method.

Preferably, the cellulose acylate film has a three or more multi-layered laminate structure, in terms of the dimensional stability or in terms of reducing the curling caused by an environmental humidity/temperature variation. Also preferably, the high-substitution layer is on both surfaces of the low-substitution layer in terms of broadening the latitude in the step of achieving the desired optical properties. More preferably, the film of the invention has a three or more multi-layered laminate structure, in which all the cellulose acylate contained in at least one internal layer is the cellulose acylate fulfilling the conditions of the above formulas (3) and (4), and all the cellulose acylate contained in the two surface layers is the cellulose acylate fulfilling the conditions of the above formulas (5) and (6). Only in the embodiments having a three or more multi-layered laminate structure, the surface layer not in contact with the support in the film formation is occasionally referred to as a skin A layer.

Preferably, the invention has a three-layered structure of skin B layer/core layer/skin A layer. The cellulose acylate film having a three-layered structure may have a constitution of high-substitution layer/low-substitution layer/high-substitution layer, or a constitution of low-substitution layer/high-substitution layer/low-substitution layer; but preferably, the film has a constitution of high-substitution layer/low-substitution layer/high-substitution layer in terms of the releasability of the film from the support in solution-casting film formation and in terms of the dimensional stability of the film.

In the cellulose acylate film having a three-layered structure, preferably, the cellulose acylate to be in both surface layers is one having the same degree of acyl substitution in terms of the production cost and the dimensional stability of the film and in the terms of reducing the curling of the film caused by an environmental humidity/heat variation.

### (Film Thickness)

Preferably, the mean thickness of the low-substitution layer is from 30 to 100 micro meters, more preferably from 30 to 80 micro meters, even more preferably from 30 to 70 micro meters. When the low-substitution layer has a mean thickness of equal to or more than 30 micro meters, the handlability of the film is improved, which is preferable. When the low-substitution layer has a mean thickness of equal to or less than 70 micro meters, the film may readily follow the ambient humidity variation and may keep its optical properties.

The mean thickness of at least one high-substitution layer is preferably from 0.2% to less than 25% of the mean thickness of the low-substitution layer. When it is equal to or more than 0.2%, the peeling abilities of the film may be sufficient, and the film may not suffer from streaky surface unevenness, thickness unevenness and uneven optical properties of the film; and when it is less than 25%, the optical properties of the low-substitution layer may be effectively used and the film may achieve sufficient optical properties. The mean thickness of at least one high-substitution layer is more preferably from 0.5 to 15% of the mean thickness of the low-substitution layer, even more preferably from 1.0 to 10% of the mean thickness of the low-substitution layer. Still more preferably, the mean thickness of both the skin layers A and B are from 0.2% to less than 25% of the mean thickness of the core layer.

Preferably, the mean thickness of the low-substitution layer is from 30 to 100 micro meters, and the mean thickness of at least one high-substitution layer is from 0.2% to less than 25% of the mean thickness of the low-substitution layer, in terms of the wavelength dispersion characteristics of retardation of the film. More preferably, the mean thickness of the low-substitution layer is from to 100 micro meters, and the mean thicknesses of both high-substitution layers are from 0.2% to less than 25% of the mean thickness of the low-substitution layer.

In the embodiments in a two or more multi-layered structure, preferably, the thickness of the low-substitution layer (preferably, the thickness of the core layer) is from 30 to 70 micro meters, more preferably from 30 to 60 micro meters, even more preferably from 30 to 50 micro meters.

In the embodiments in two or more multi-layered structure, preferably, the thickness of the high-substitution layer (preferably, the thickness of the surface layer on both sides of the film) is from 0.5 to 20 micro meters, more preferably from 0.5 to 10 micro meters, even more preferably from 0.5 to 3 micro meters.

In an exemplary laminated structure having three layers, an inner layer (a core layer) corresponds to the low-substitution layer, and surface layers (a skin layer B and a skin layer A) each corresponds to the high-substitution layer. More preferably, the skin layers B and A each have a smaller thickness than that of the core layer. The preferred conditions on the thickness of the surface layer are the same as those in a laminated structure having three or more layers.

### (Width of Film)

The width of the film composed of the low-substitution layer or of the film composed of the low-substitution layer and the high-substitution layer ranges preferably from 700 to 3000 mm, more preferably from 1000 to 2800 mm, and most preferably from 1500 to 2500 mm.

In addition, the film preferably has a width of 700 to 3000 mm, and a ΔRe of 10 nm or less.

### (Method of Manufacturing Low-Substitution Cellulose Acylate Film)

An exemplary method of manufacturing a low-substitution cellulose acylate film, which refers to the film composed of the low-substitution layer or the film composed of the low-substitution layer and the high-substitution layer, involves forming a cellulose-acylate lamination film through sequential casting or simultaneous co-casting of a cellulose acylate solution for a low-substitution layer containing a cellulose acylate satisfying Formula (1) and an non-phosphorylated ester compound if desired, and a cellulose acylate solution for a high-substitution layer containing the cellulose acylate satisfying Formula (2), and stretching the film containing 5 mass % residual solvent relative to the total mass of the film at a temperature of Tg-30° C. or more, where Tg refers to a glass transition temperature of the cellulose-acylate lamination film.

Preferably, the cellulose acylate laminate film is formed according to a solvent casting method. For production examples for cellulose acylate film according to a solvent casting method, referred to are U.S. Pat. Nos. 2,336,310, 2,367,603, 2,492,078, 2,492,977, 2,492,978, 2,607,704, 2,739,069 and 2,739,070, British Patents 640731 and 736892, JP-B 45-4554 and 49-5614, JP-A 60-176834, 60-203430 and 62-115035. The cellulose acylate film may be stretched. For the method and the condition for stretching treatment, referred to are, for example, JP-A 62-115035, 4-152125, 4-284211, 4-298310, 11-48271.

Examples of the solution casting method include a method of uniformly extruding a prepared dope through a pressure die onto a metal support, a doctor blade method of regulating the thickness of the dope once cast on a metal support, with a blade, and a method with a reverse roll coater of regulating the thickness with a reverse-rotating roll. Preferred is the method with a pressure die. Examples of the pressure die include a coat hanger-type die, and a T-die. Any of these is favorably used herein. Apart from the methods mentioned herein, any other various known methods of forming a cellulose triacetate solution into films are also employable. In consideration of the difference in the boiling point of the solvent to be used, the conditions may be set, and the same advantages as in the reference publications can be attained here.

The low-degree substitution film is produced in a process comprising a step of forming a film by applying the cellulose acylate solution (casting dope) for low-substitution layer that contains a cellulose acylate fulfilling the condition of formula (1) and, if desired, a non-phosphate ester compound, and the cellulose acylate solution for high-substitution layer that contains a cellulose acylate fulfilling the condition of formula (2) onto a support, and a step of stretching the resulting film.

In the production method, preferably, the viscosity at 25 degrees Celsius of the cellulose acylate solution for low-substitution layer is higher by at least 10% than the viscosity at 25 degrees Celsius of the cellulose acylate solution for high-substitution layer, in terms of the transversal distribution of the laminate film layers and in terms of the aptitude for production of the laminate film.

For preparing the low-degree substitution cellulose acylate film, a laminate casting method such as a co-casting method, a sequential casting method, and a coating method are preferably used. A simultaneous co-casting method is more preferable in terms of improving the stability of production and reducing the production cost.

In the embodiments where the low-degree substitution cellulose acylate film is prepared according to a co-casting method or a sequential casting method, at first, a cellulose acetate solution (dope) for each layer is prepared. In the co-casting method (superimposition simultaneous casting), casting dopes to be the constitutive layers (three or more layers) are extruded out through a casting T-die of simultaneously extruding the dopes through the respective slits onto a casting support (band or drum), and simultaneously cast thereon, and then peeled off from the support at a suitable time to give a film. FIG. 2 is a cross-sectional view showing the condition of simultaneous extrusion and casting of a surface layer dope 1 and core layer dopes 2 onto a casting support 4 through a co-casting T-die 3, thereby forming three layers on the support.

In the sequential casting method, a casting dope for the first layer is first extruded out and cast through a casting T-die onto a casting support, and after it is dried or not, a casting dope for the second layer is extruded out and cast onto it through a casting T-die, and in that manner, if desired, other dope(s) are cast and laminated on the previous layer up to be three (or more) layers, and at a suitable time, the resulting laminate is peeled off from the support and dried to be a film. In the coating method, in general, a film of the core layer is formed according to a solution casting method, then a coating liquid to be the surface layer is prepared, and using a suitable coating unit, the coating liquid is applied onto the core film on one side thereof at a time or on both sides simultaneously, and dried to give a laminate-structured film.

As the endlessly running metal support for use in producing the film of the invention, usable is a drum of which the surface is mirror-finished by chromium plating, or a stainless belt (band) of which the surface is mirror-finished by polishing. One or more pressure dies may be arranged above the metal support. Preferably, one or two pressure dies are arranged. In case where two or more pressure dies are arranged, the dope to be cast may be divided into portions suitable for the individual dies; or the dope may be fed to the die at a suitable proportion via a plurality of precision metering gear pumps. The temperature of the cellulose acylate solution to be case is preferably from −10 to 55 degrees Celsius, more preferably from 25 to 50 degrees Celsius. In this case, the solution temperature may be the same throughout the entire process, or may differ in different sites of the process. In case where the temperature differs in different sites, the dope shall have the desired temperature just before cast.

The method involves stretching the formed film containing 5 mass % residual solvent relative to the total mass of the film at a temperature of Tg-30° C. or more. For example, the stretching imparts desirable optical properties more particularly wavelength dispersion characteristics to the film, and desirable retardation to the cellulose acylate film. The cellulose acylate film is preferably stretched in either a film conveying direction or a direction (width direction) perpendicular to the conveying direction, and is more preferably stretched in a direction (width direction) perpendicular to the conveying direction from the viewpoint of a subsequent polarizing-plate processing step using the cellulose acylate film.

Such stretching of a film in the width direction is disclosed in JP-A-62-115035, JP-A-4-152125, JP-A-4-284211, JP-A-4-298310, and JP-A-11-48271, for example. In stretching of a film in the longitudinal direction, for example, the rotation speed of a film conveying roller is adjusted such that the film winding rate is higher than the film separation rate, thereby the film is stretched. In stretching of a film in the width direction, while a film is conveyed with its two lateral ends held by a tenter, the width of the tenter is gradually expanded, thereby the film can also be stretched. A dried film can be stretched with a stretching machine preferably through uniaxial stretching with a long stretching machine.

The stretching ratio of the low-substitution cellulose acylate film ranges preferably from 5% to 200%, more preferably from 5% to 100%, and most preferably from 5% to 50%.

If the low-substitution cellulose acylate film is used as a protective film for a polarizer, the transmission axis of the polarizer must be disposed parallel or orthogonal to the in-plane slow axis of the low-substitution cellulose acylate film in order to suppress light leakage in oblique view of a polarizing plate. The transmission axis of a polarizer, which is continuously produced into a rolled film, is typically parallel to a width direction of the rolled film; hence, the in-plane slow axis of the protective film in a rolled form must be parallel or orthogonal to the width direction of the film in order to continuously bond the polarizer in a rolled form to the protective film composed of the low-substitution cellulose acylate film in a rolled form. Thus, it is preferred the film be further stretched in the width direction. The film may be stretched in the middle of film formation step, or a rolled-up film may be stretched. In the above-described manufacturing process of the film, the film containing a residual solvent is preferably stretched in the middle of the film formation step.

Preferably, the production method preferably further comprises a step of drying the cellulose acylate laminate film after the stretching step, and a step of stretching the dried cellulose acylate laminate film at a temperature of equal to or higher than Tg-10 degrees Celsius, in terms of enhancing the retardation of the film.

For drying the dope on a metal support in production of the low-degree substitution cellulose acylate film, generally employable is a method of applying hot air to the surface of the metal support (drum or belt), or that is, on the surface of the web on the metal support; a method of applying hot air to the back of the drum or belt; or a back side liquid heat transfer method that comprises contacting a temperature-controlled liquid with the opposite side of the dope-cast surface of the belt or drum, or that is, the back of the belt or drum to thereby heat the belt or drum by heat transmission to control the surface temperature thereof. Preferred is the backside liquid heat transfer method. The surface temperature of the metal support before the dope is cast thereon may be any degree so far as it is not higher than the boiling point of the solvent used in the dope. However, for promoting the drying or for making the dope lose its flowability on the metal support, preferably, the temperature is set to be lower by from 1 to 10 degrees Celsius than the boiling point of the solvent having the lowest boiling point of all the solvents in the dope. In case where the cast dope is peeled off after cooled but not dried, then this shall not apply thereto.

For controlling the thickness of the film, the solid concentration in the dope, the slit gap of the die nozzle, the extrusion pressure from the die, and the metal support speed may be suitably regulated so that the formed film could have a desired thickness.

Produced in the manner as above, the length of the low-degree substitution cellulose acylate film is preferably from 100 to 10000 m per roll, more preferably from 500 to 7000 m, even more preferably from 1000 to 6000 m. In rolling up the film, preferably, at least one edge thereof is knurled, and the knurling width is preferably from 3 mm to 50 mm, more preferably from 5 mm to 30 mm, and the knurling height is preferably from 0.5 to 500 micro meters, more preferably from 1 to 200 micro meters. This may be one-way or double-way knurling.

### Optically Compensatory Film:

In an embodiment of the invention where the low-substitution layer is provided as an outer protective film of the polarizer, an optically compensatory film can be disposed between each of the pair of polarizers and the liquid crystal cell. The optically compensatory film includes a support composed of a polymer film, and an optically anisotropic layer the orientation of which is fixed to hybrid alignment. The optically compensatory film provided together with the low-substitution layer leads to an improvement in viewing angle characteristics in addition to the advantageous effects of the invention, i.e., a reduction in frame-like light leakage.

Either rod-like liquid crystal or discotic liquid crystal may be used as a liquid crystal compound used in formation of the optically anisotropic layer. The discotic liquid crystal is preferred from the viewpoint of an improvement in viewing angle characteristics. Examples of the discotic liquid crystal include triphenylene compounds and trisubstituted benzene compounds. In particular, the triphenylene compounds are preferred, examples of which include the compounds represented by General formula (DI) and the specific examples thereof described in paragraphs [0033] to [0098] in JP-A-2009-98645. In addition, JP-A-2009-98645 also discloses additives usable in the formation of the optically anisotropic layer and a formation procedure thereof.

In the optically anisotropic layer, the molecules of the liquid crystal compound are fixed to hybrid alignment. In the hybrid alignment, an angle (hereinafter, referred to as “tilt angle”), which is defined by a major axis of each molecule and a layer plane in the rod-like liquid crystal, or defined by a discotic plane of each molecule and a layer plane in the discotic liquid crystal, varies (increases or decreases) in a layer thickness direction. The optically anisotropic layer is commonly formed by aligning a composition containing a discotic liquid crystal compound on a surface of the alignment film; hence, the optically anisotropic layer has an interface with the alignment film and an interface with air. In an embodiment of the hybrid alignment, the tilt angle is large in a region close to the alignment film interface, and small in a region close to the air interface, namely, the tilt angle decreases from the alignment film interface toward the air interface (hereinafter, referred to as “reversed hybrid alignment”). In another embodiment of the hybrid alignment, the tilt angle is small in the region close to the alignment film interface, and large in the region close to the air interface, namely, the tilt angle increases from the alignment film interface toward the air interface (hereinafter, referred to as “normal hybrid alignment”). Although the optically anisotropic layer may have either hybrid alignment from the viewpoint of viewing angle contrast, the reversed hybrid alignment is preferred from the viewpoint of front contrast.

The optically compensatory film having the optically anisotropic layer containing the discotic liquid crystal fixed to hybrid alignment preferably exhibits the following optical characteristics.

The retardation R[0°] for incident light having a wavelength of 550 nm, which is measured from a normal direction to the optically compensatory film, preferably satisfies the following expression:

10 nm≦R[0°]≦150 nm,

and the ratio of the retardation R[+40°], which is measured from a direction orthogonal to the in-plane slow axis of the optically compensatory film and tilted by +40° from a normal toward a plane of the retardation layer in a plane (an incident plane) including the normal, to the retardation R[−40′], which is measured from a direction tilted by −40° from the normal, where the R[−40°] is smaller than the R[+40°], preferably satisfies the following expression:

1<R[+40°]/R[−40°].

The R[0°] preferably ranges from 10 to 150 nm. Furthermore, the ratio R[+40°]/R[−40°] preferably ranges from 1.1 or more.

The optically anisotropic layer may be formed with an alignment film composed of polyvinyl alcohol or modified polyvinyl alcohol as a main component and having a rubbed surface.

Any polymer film is used as the support for the optically anisotropic layer without limitation. Examples of the polymer film for the support include films of cellulose acylate (not used in the low-substitution layer), polycarbonate, polysulfone, polyether sulfone, polyacrylate, polymethacrylate, and cyclic polyolefin. A cellulose acylate film is preferred, and a cellulose acetate film is more preferred.

### First and Second Polarizer:

According to the invention, the first and the second polarizers are not limited. The linear polarizing film may be selected from coating-type polarizing films as typified by Optiva Inc., iodine-based polarizing films and dichroic-dye based polarizing films. Iodine or dichroic dye molecules are oriented in binder so as to have a polarizing capability. Iodine or dichroic dye molecules may be oriented along with binder molecules, or iodine molecules may aggregate themselves in the same manner of liquid crystal and be aligned in a direction. Generally, commercially available polarizing films are produced by soaking a stretched polymer film in a solution of iodine or dichroic dye and impregnating the polymer film with molecules of iodine or dichroic dye.

### Outer Protective Film:

The liquid crystal display of the present invention preferably has outer protective films disposed on the respective outer sides of first and second polarizers. Any protective film may be used as the outer protective film. Examples of the protective film include cellulose acetate films, cyclic polyolefin polymer films, polyolefin polymer films, polyester polymer films, polycarbonate polymer films, acrylate polymer films, polystyrene polymer films, and polyamide polymer films. Commercially available cellulose acetate films (for example, “TD80U” from Fujifilm Corporation) can also be used.

At least one of the two outer protective films is preferably composed of the low-substitution cellulose acylate film from the viewpoint of a reduction in frame-like light leakage.

At least one (preferably both) of the two outer protective films is advantageously selected from films of cyclic olefin resin, polyolefin resin, polyester resin, polycarbonate resin, acrylate rein, and cellulose acylate resin from the viewpoint of moisture resistance.

### Twisted-Alignment-Mode Liquid Crystal Cell:

Any twisted-alignment-mode, for example, a TN mode and an STN mode, liquid crystal cell can be used without limitation. Any known configuration of the twisted-alignment-mode liquid crystal cell can be used. For example, a TN-mode liquid crystal cell commonly has a liquid crystal layer composed of a nematic liquid crystal material, where the liquid crystal layer is twist-aligned during application of no drive voltage, and is vertically aligned with respect to a substrate surface during application of drive voltage. The upper and lower polarizers are disposed with their transmission axes orthogonal to each other. Thus, during application of no drive voltage, linearly polarized light, which is incident from the backlight disposed at the back of the lower polarizer onto the liquid crystal cell, is rotated by 90° along the twisted alignment of the liquid crystal layer, and passes through the transmission axis of the upper polarizer, resulting in white display. During application of drive voltage, linearly polarized light, which is incident onto the liquid crystal cell, passes through the liquid crystal cell while being polarized; hence, the linearly polarized light is blocked by the upper polarizer, resulting in black display. The liquid crystal layer of the TN-mode liquid crystal cell commonly has a product Δnd of thickness d (μm) and refractive-index anisotropy Δn of about 0.1 to 1.5 μm.

The advantageous effects of the invention can also be given in embodiments of liquid crystal displays other than the twisted alignment mode, for example, ECB-mode and OCB-mode liquid crystal displays.

### EXAMPLES

The present invention will be explained to further detail, referring to Examples. Note that the materials, reagents, amounts and ratios of substances, operations and so forth explained in Examples below may appropriately be modified without departing from the spirit of the present invention. The scope of the present invention is, therefore, not limited to the specific examples described below.

### 1. Example of Production of Cellulose Acylate Film

### (Preparation of Cellulose Acylate)

Cellulose acylate was synthesized in accordance with the procedures described in JP-A-10-45804 and JP-A-8-231761, and the degree of substitution of the cellulose acylate was measured. Specifically, sulfuric acid (7.8 parts by mass to 100 parts by mass of cellulose) was added as a catalyst, and a carboxylic acid to be a material for an acyl substituent was added for acylation at 40° C. In this acylation, the type and amount of the carboxylic acid were determined to control the type and the degree of substitution of the acyl substituent. After acylation, the film was aged at 40° C. The low molecular-weight components in the cellulose acylate were then removed with acetone.

(Preparation of Cellulose Acylate Solutions “C01” to “C12”)

The following composition was put into a mixing tank, and was stirred to dissolve the components, thereby cellulose acylate solutions were prepared. The amounts of the solvents (methylene chloride and methanol) were appropriately adjusted such that the solid content of each cellulose acylate solution was 22 mass %, provided that the solid content of the cellulose acylate solution C05 was 19 mass %.

| | | |
|---|---|---|
| Cellulose acylate having a degree of | 100 | parts by mass |
| substitution shown in Table 1 | | |

Additives having proportions shown in Table 1

| | | |
|---|---|---|
| Methylene chloride | 365.5 | parts by mass |
| Methanol | 54.6 | parts by mass |

TABLE 1

| | Cellulose acylate | | Additive | |
|---|---|---|---|---|
| Solution | Degree of | Additive Amount | Com- | Additive Amount |
| No. | substitution | (parts by mass) | pound | (parts by mass) |
| C01 | 2.45 | 100 | A*1 | 40 |
| C02 | 1.95 | 100 | A*1 | 40 |
| C03 | 2.2 | 100 | A*1 | 40 |
| C04 | 2.65 | 100 | A*1 | 40 |
| C05 | 2.8 | 100 | A*1 | 20 |
| C06 | 2.45 | 100 | B*2 | 34 |
| C07 | 2.45 | 100 | C*3 | 32 |
| C08 | 2.45 | 100 | D*4 | 33 |
| C09 | 2.81 | 100 | A*1 | 28 |
| C10 | 2.81 | 100 | A*1 | 12 |
| C11 | 2.45 | 100 | A*1 | 19 |
| C12 | 2.8 | 100 | A*1 | 10 |

*1Compound A refers to a copolymer of terephthalic acid, succinic acid, ethylene glycol, and propylene glycol (monomer ratio (mol %): 27.5/22.5/25/25).
*2Compound B refers to a copolymer of terephthalic acid, phthalic acid, adipic acid, succinic acid, and ethylene glycol (monomer ratio (mol %): 22.5/2.5/10/15/50).
*3Compound C refers to a copolymer of terephthalic acid, phthalic acid, adipic acid, and ethylene glycol (monomer ratio (mol %): 22.5/2.5/25/50).
*4Compound D refers to a copolymer of terephthalic acid, phthalic acid, succinic acid, propylene glycol, and ethylene glycol (monomer ratio (mol %): 22.5/2.5/25/37.5/12.5).

Each of the compounds A to D is a non-phosphate ester compound functioning as a retardation developer. The ends of the compounds A to C other than the compound D are each capped by an acetyl group.

### (Production of Cellulose Acylate Film)

Cellulose acylate films were produced by a single casting or co-casting process described below with one or more of the cellulose acylate solutions. Table 2 shows the stretching temperatures and the stretching ratios.

### Single Casting Process:

One of the cellulose acylate solutions in Table 2 was casted on a belt stretching machine into a thickness of 60 μm. The resultant web (film) was separated from a belt, was pinched with clips, and was laterally stretched with a tenter at a temperature and a stretching ratio shown in Table 2. The web was then detached from the clips and was dried at 130° C. for 20 min to yield a cellulose acylate film.

### Co-Casting Process:

The cellulose acylate solution C01 or C11 was casted into a core layer of 56 μm in thickness and the cellulose acylate solution C09 or C10 was casted into a skin layer A of 2 μm in thickness, on a belt stretching machine. The resultant web (film) was then separated from the belt, was pinched with clips, and was laterally stretched with a tenter at a temperature and a stretching ratio shown in Table 2. The web was then detached from the clips and was dried at 130° C. for 20 min to yield a cellulose acylate film.

Table 2 shows the configurations, stretching conditions, and properties of the resultant films.

TABLE 2

| | Configuration of | | Configuration of | | | | | | |
|---|---|---|---|---|---|---|---|---|---|
| | Core layer | | Skin layer A | | Stretching condition | | Characteristics of film | | |
| | | Thickness | | Thickness | Temperature | | Thickness | Re (550) | Rth (550) |
| Sample No. | Solution | (μm) | Solution | (μm) | (° C.) | Sretching raio | (μm) | (nm) | (nm) |
| Film 1 | C01 | 60 | — | — | 195 | 15% | 60 | 9 | 40 |
| Film 2 | C02 | 25 | — | — | 195 | 13% | 25 | 7 | 38 |
| Film 3 | C03 | 35 | — | — | 195 | 14% | 35 | 8 | 39 |
| Film 4 | C04 | 70 | — | — | 195 | 15% | 70 | 10 | 40 |
| Film 5 | C05 | 85 | — | — | 195 | 15% | 85 | 9 | 41 |
| Film 6 | C06 | 59 | — | — | 195 | 15% | 59 | 9 | 40 |
| Film 7 | C07 | 60 | — | — | 195 | 15% | 60 | 10 | 41 |
| Film 8 | C08 | 61 | — | — | 195 | 15% | 61 | 9 | 40 |
| Film 9 | C01 | 56 | C09 | 2 | 172 | 30% | 58 | 10 | 40 |
| Film 10 | C11 | 56 | C10 | 2 | 172 | 30% | 58 | 49 | 120 |
| Film 11 | C11 | 61 | — | — | 195 | 22% | 61 | 21 | 82 |
| Film 12 | C11 | 60 | — | — | 172 | 30% | 60 | 50 | 120 |
| Film 13 | C12 | 85 | — | — | 180 | 12% | 85 | 10 | 90 |
| Film 14*1 | C11 | 56 | C10 | 2 | 172 | 30% | 60 | 48 | 118 |

*1Film 14 was formed through co-casting of the solutions C10/C11/C10, and C10 such that the skin layer A was formed on both sides of the core layer.

Film 2 was not smoothly handled during the formation of a web-like film due to its small thickness, which is disadvantageous from the viewpoint of production stability. In addition, such a small thickness of Film 2 caused inferior surface morphology of the film such as creasing.

The films 9 and 10, each having a cellulose-acylate skin layer A with a high degree of substitution on the belt surface, were readily separated from the belt due to a small load exerted thereon compared with other films, which is advantageous from the viewpoint of production stability.

### 2. Example of Production of Polarizing Plate

Any two of the cellulose acylate films produced as described above were combined and bonded to the respective surfaces of a linearly polarizing film to yield a polarizing plate. The surface to be bonded of each film was alkali-saponified. The linearly polarizing film had a thickness of 20 μm, and was prepared by continuously stretching a polyvinyl alcohol film of 80 μm in thickness to five times its original length in an iodine aqueous solution, and then drying the stretched film. An aqueous 3% polyvinyl alcohol (PVA-117H, available from Kuraray Co., Ltd.) solution was used as an adhesive agent. With Films 3 and 4 each being a laminate of the low-substitution layer and the high-substitution layer, the surface of the high-substitution layer was bonded to the surface of the polarizing film.

### 3. Example of Production of Liquid Crystal Display and Evaluation Thereof

### (1) Production of TN-Mode Liquid Crystal Display

A pair of polarizing plates originally provided in a liquid crystal display (V2200eco, from BENQ Japan Co., Ltd.) including a TN liquid crystal cell were removed. Two of the polarizing plates produced as described above were bonded to a viewer side and a backlight side of the liquid crystal cell, respectively, with an adhesive agent. In this bonding, the polarizing plates were disposed such that the transmission axis of one polarizing plate on the viewer side was orthogonal to the transmission axis of the other polarizing plate on the backlight side.

TN-mode liquid crystal displays having configurations shown in Table 3 were produced.

### (3) Evaluation of Liquid Crystal Display

### (Evaluation on Frame-Like Light Leakage)

Each liquid crystal display produced as described above was dried at 70° C. for 170 hr in a dryer and then taken out. The liquid crystal display was then turned into an entirely black display mode and visually observed in a dark room to evaluate light leakage in accordance with the following criterion.

A: no light leakage was observed in the periphery of the polarizing plate (practically no problem).

B: substantially no light leakage was observed in the periphery of the polarizing plate (practically no problem).

C: some light leakage was observed in the periphery of the polarizing plate though it was practically not problematic.

D: light leakage was observed in the periphery of the polarizing plate at a practically problematic level.

(Evaluation on Front CR)

With each liquid crystal display, the brightness in a front direction (normal direction to a display surface) was measured in each of the black display and white display modes with a tester “EZ-Contrast XL88” (from ELDI), and contrast ratios (white display/black display) were calculated and evaluated in accordance with the following criterion.

A: front CR of 900 to less than 1200.

B: front CR of 800 to less than 900.

C: front CR of less than 800.

(Evaluation on CR Viewing Angle)

With each liquid crystal display, a viewing angle was measured in each of the black display and white display modes with a tester “EZ-Contrast XL88” (from ELDI). Each of the vertical and horizontal regions having a contrast ratio (white display mode/black display mode) of 10 or more was defined as a viewing angle. The viewing angle was evaluated in accordance with the following criterion. Table 3 shows the results.

If the total of the vertical and horizontal viewing angles, each providing a contrast of 10 or more, is 320° or more, practically excellent display characteristics are given.

### [Evaluation]

A: total of vertical and horizontal angles, each providing CR≧10, is 320° or more.

B: total of vertical and horizontal angles, each providing CR≧10, is more than 240° to less than 320°.

C: total of vertical and horizontal angles, each providing CR≧10, is more than 200° to less than 240°.

D: total of vertical and horizontal angles, each providing CR≧10, is more than 160° to less than 200°.

E: total of vertical and horizontal angles, each providing CR≧10, is 160° or less.

TABLE 3

| | | | | | | | | | | | Comparative |
|---|---|---|---|---|---|---|---|---|---|---|---|
| | | Example 1 | Example 2 | Example 3 | Example 4 | Example 5 | Example 6 | Example 7 | Example 8 | Example 9 | Example 1 |
| Outer | Film No. | Film 5 | Film 5 | Film 5 | Film 5 | Film 1 | Film 1 | Film 1 | Film 5 | Film 5 | Film 5 |
| protective | Structure *1 | High | High | High | High | Low | Low | Low | High | High | High |
| film (on | Degree of | 2.8 | 2.8 | 2.8 | 2.8 | 2.45 | 2.45 | 2.45 | 2.8 | 2.8 | 2.8 |
| the viewing | substitution | | | | | | | | | | |
| side) | Thickness | 85 | 85 | 85 | 85 | 60 | 60 | 60 | 85 | 85 | 85 |
| | Re (550) | 9 | 9 | 9 | 9 | 9 | 9 | 9 | 9 | 9 | 9 |
| | Rth (550) | 41 | 41 | 41 | 41 | 40 | 40 | 40 | 41 | 41 | 41 |
| First polarizer | | PVA Linearly polarizing film | | | | | | | | | |
| Inner | Film No. | Film 1 | Film 3 | Film 4 | Film 9 | Film 10 | Film 5 | Film 1 | Film 11 | Film 12 | Film 5 |
| protective | Structure *1 | Low | Low | Low | High-low | High-low | High | Low | Low | Low | High |
| film | Degree of | 2.45 | 2.2 | 2.65 | 2.45 | 2.45 | 2.8 | 2.45 | 2.45 | 2.45 | 2.8 |
| | substitution | | | | | | | | | | |
| | Thickness | 60 | 35 | 70 | 58 | 58 | 85 | 60 | 61 | 60 | 85 |
| | Re (550) | 9 | 8 | 10 | 0 | 49 | 9 | 9 | 21 | 50 | 9 |
| | Rth (550) | 40 | 39 | 40 | 40 | 120 | 41 | 40 | 82 | 120 | 41 |
| Liquid crystal cell | | TN liquid crystal cell | | | | | | | | | |
| Inner | Film No. | Film 1 | Film 3 | Film 4 | Film 9 | Film 10 | Film 5 | Film 1 | Film 11 | Film 12 | Film 5 |
| protective | Structure *1 | Low | Low | Low | High-low | High-low | High | Low | Low | Low | High |
| film | Degree of | 2.45 | 2.2 | 2.65 | 2.45 | 2.45 | 2.8 | 2.45 | 2.45 | 2.45 | 2.8 |
| | substitution | | | | | | | | | | |
| | Thickness | 60 | 35 | 70 | 58 | 58 | 85 | 60 | 61 | 60 | 85 |
| | Re (550) | 9 | 8 | 10 | 0 | 49 | 9 | 9 | 21 | 50 | 9 |
| | Rth (550) | 40 | 39 | 40 | 40 | 120 | 41 | 40 | 82 | 120 | 41 |
| First polarizer | | PVA Linearly polarizing film | | | | | | | | | |
| Outer | Film No. | Film 5 | Film 5 | Film 5 | Film 5 | Film 1 | Film 1 | Film 1 | Film 5 | Film 5 | Film 5 |
| protective | Structure *1 | High | High | High | High | Low | Low | Low | High | High | High |
| film (on | Degree of | 2.8 | 2.8 | 2.8 | 2.8 | 2.45 | 2.45 | 2.45 | 2.8 | 2.8 | 2.8 |
| the BL | substitution | | | | | | | | | | |
| side) | Thickness | 85 | 85 | 85 | 85 | 60 | 60 | 60 | 85 | 85 | 85 |
| | Re (550) | 9 | 9 | 9 | 9 | 9 | 9 | 9 | 9 | 9 | 9 |
| | Rth (550) | 41 | 41 | 41 | 41 | 40 | 40 | 40 | 41 | 41 | 41 |
| Frame-like | Evaluation | B | A | C | B | A | B | A | B | B | D |
| light | | | | | | | | | | | |
| leakage | | | | | | | | | | | |
| Front CR | Evaluation | A | A | A | A | A | A | A | A | A | B |
| CR | Evaluation | D | D | D | D | B | D | D | C | B | D |
| Viewing | | | | | | | | | | | |
| Angle | | | | | | | | | | | |

*1: “High” refers to a single structure of a high-substitution layer, “Low” refers to a single structure of a low-substitution layer, and “High-low” refers to a laminate of a high-substitution layer and a low-substitution layer, where the high-substitution layer is adjacent to a polarizer.

Liquid crystal displays were produced as in Example 1 except that the inner protective film (support) was changed from Film 1 to Films 6, 7, 8, and 14, and the display performance of each liquid crystal display was evaluated as in Example 1. The results are shown in Table 4. The liquid crystal displays produced using Films 6, 7, 8, and 14 exhibited reduced frame-like light leakage and improved display characteristics as in Example 1. Table 4 also shows the results of Example 1.

TABLE 4

| | | Example 1 | Example 10 | Example 11 | Example 12 | Example 13 |
|---|---|---|---|---|---|---|
| Outer protective film | Film No. | Film 5 | Film 5 | Film 5 | Film 5 | Film 5 |
| (on the viewing side) | Structure *1 | High | High | High | High | High |
| | Degree of | 2.8 | 2.8 | 2.8 | 2.8 | 2.8 |
| | substitution | | | | | |
| | Thickness | 85 | 85 | 85 | 85 | 85 |
| | Re (550) | 9 | 9 | 9 | 9 | 9 |
| | Rth (550) | 41 | 41 | 41 | 41 | 41 |
| First polarizer | | PVA Linearly polarizing film | | | | |
| Inner protective film | Film No. | Film 1 | Film 6 | Film 7 | Film 8 | Film 14 |
| | Structure *1 | Low | Low | Low | Low | High-low-high |
| | Degree of | 2.45 | 2.45 | 2.45 | 2.45 | High: 2.81 |
| | substitution | | | | | Low: 2.45 |
| | Thickness | 60 | 59 | 60 | 61 | 60 |
| | Re (550) | 9 | 9 | 10 | 9 | 48 |
| | Rth (550) | 40 | 40 | 41 | 40 | 118 |
| Liquid crystal cell | | TN liquid crystal cell | | | | |
| Inner protective film | Film No. | Film 1 | Film 6 | Film 7 | Film 8 | Film 14 |
| | Structure *1 | Low | Low | Low | Low | High-low-high |
| | Degree of | 2.45 | 2.45 | 2.45 | 2.45 | High: 2.81 |
| | substitution | | | | | Low: 2.45 |
| | Thickness | 60 | 59 | 60 | 61 | 60 |
| | Re (550) | 9 | 9 | 10 | 9 | 48 |
| | Rth (550) | 40 | 40 | 41 | 40 | 118 |
| First polarizer | | PVA Linearly polarizing film | | | | |
| Outer protective film | Film No. | Film 5 | Film 5 | Film 5 | Film 5 | Film 5 |
| (on the BL side) | Structure *1 | High | High | High | High | High |
| | Degree of | 2.8 | 2.8 | 2.8 | 2.8 | 2.8 |
| | substitution | | | | | |
| | Thickness | 85 | 85 | 85 | 85 | 85 |
| | Re (550) | 9 | 9 | 9 | 9 | 9 |
| | Rth (550) | 41 | 41 | 41 | 41 | 41 |
| Frame-like light leakage | Evaluation | B | B | B | B | A |
| Front CR | Evaluation | A | A | A | A | A |
| CR Viewing Angle | Evaluation | D | D | D | D | B |

*1: “High” refers to a single structure of a high-substitution layer, “Low” refers to a single structure of a low-substitution layer, and “High-low-high” refers to a laminate of a high-substitution layer, a low-substitution layer, and a high-substitution layer, where one of the high-substitution layers is adjacent to a polarizer.

All the liquid crystal displays of Examples of the invention exhibit reduced frame-like light leakage. The cause of this effect is speculated as follows. In each of the liquid crystal displays of Examples, the film consisting of or including the low-substitution layer (about 60 μm in thickness) is disposed as inner and/or outer protective films of a polarizer; hence, the thickness of the optically compensatory film can be reduced by about 20 μm compared with the liquid crystal display of the comparative example, resulting in a reduction in distortion of the liquid crystal panel and/or the polarizing plate due to, for example, heat.

### 4. Example 14

The liquid crystal display of Example 5 was modified to a liquid crystal display of Example 14, as follows.

### (Formation of Alignment Film)

A coating solution for alignment layer, having the following composition, was continuously applied onto a saponified surface of Film 13 with a #16 wire bar. The coating was then dried in hot air at 60° C. for 60 sec and then at 90° C. for 150 sec. The surface of the resultant coating was rubbed through rotation of a rubbing roll at 500 rpm in a direction parallel to a conveying direction to give an alignment film.

### (Composition of Coating Solution for Alignment Film)

| | | |
|---|---|---|
| Modified polyvinyl alcohol described below | 20 | parts by mass |
| Water | 360 | parts by mass |
| Methanol | 120 | parts by mass |
| Glutaraldehyde (crosslinking agent) | 1 | part by mass |

Modified polyvinyl alcohol

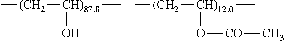

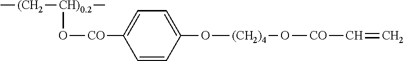

### (Formation of Optically Anisotropic Layer)

The coating solution was continuously applied onto the surface of the alignment film on Film 13 with a #3.2 wire bar. The solvent in the coating was evaporated during a step of continuously heating the coating from room temperature to 100° C., and the coating was then heated for about 90 sec in a drying zone at 135° C. in such a manner that wind velocity in a direction parallel to the film conveying direction was 1.5 m/sec at a surface of the discotic liquid crystal compound layer, thereby the discotic liquid crystal compound was aligned. The coating was then conveyed into a drying zone at 80° C. In the drying zone, the discotic liquid crystal compound was irradiated with ultraviolet rays at an illuminance of 600 mW for 4 sec by an ultraviolet irradiator (UV lamp, output power: 160 W/cm, emission wavelength: 1.6 m) while the film surface temperature was kept at about 100° C., thereby the discotic liquid crystal compound was fixed to that alignment through a crosslinking reaction. The coating was then cooled to room temperature to form an optically anisotropic layer on the surface of Film 13, resulting in production of an optically compensatory film.

### (Composition of Coating Solution for Optically Anisotropic Layer)

| | | |
|---|---|---|
| Methyl ethyl ketone | 98 | parts by mass |
| Discotic liquid crystal compound (1) described below | 41.01 | parts by mass |
| Ethylene oxide modified trimethlolpropanetriacrylate | 4.06 | parts by mass |
| (V#360, from Osaka Organic Chemicals Co., Ltd.), Cellulose acetate butyrate | 0.34 | part by mass |
| (CAB551-0. 2, from Eastman Chemical Company) Cellulose acetate butyrate | 0.11 | part by mass |
| (CAB531-1, from Eastman Chemical Company) Fluoro-aliphatic-group-containing polymer 1 | 0.13 | parts by mass |
| described below | | |
| Fluoro-aliphatic-group-containing polymer 2 described below | 0.03 | parts by mass |
| Photopolymerization initiator (IIRGACURE 907, from Ciba Geigy) | 1.35 | parts by mass |
| Sensitizer (KAYACURE DETX, from NIPPON KAYAKU CO., LTD.) | 0.45 | parts by mass |

Discotic liquid crystal compound 1 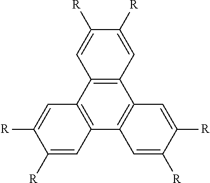 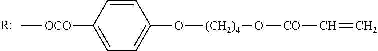
Fluoro-aliphatic-group-containing polymer 1 (a/b/c = 20/20/60 (wt %)) 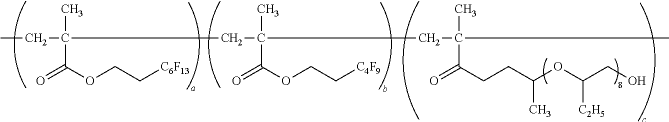
Fluoro-aliphatic-group-containing polymer 2 (a/b = 98/2 (wt %))

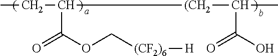

### (Measurement of Optical Characteristic)

The retardation in-plane Re (550) at a wavelength of 550 nm of the optically compensatory film was determined as 44 nm with KOBRA-WR (from Oji Scientific Instruments). Light having a wavelength of 550 nm was incident from a direction tilted by ±40° from a normal direction in a plane orthogonal to the slow axis of the optically compensatory film to measure the retardations R[+40°] and R[−40°], and the calculated ratio R[+40°]/R[−40°] was 3.2. The Re was measured while the optically compensatory film was placed in a direction giving R[+40°]>R[−40°].

This revealed that the discotic liquid-crystal compound was hybrid-aligned in the optically anisotropic layer.

A TN-mode liquid crystal display was produced, which had a similar configuration to that in Example 5 except that two optically compensatory films prepared as described above were bonded to the surfaces of the polarizer as inner protective films instead of Film 5.

The resultant TN-mode liquid crystal display exhibited reduced frame-like light leakage as in Example 5 and noticeably improved CR viewing angle characteristics compared with those in Example 5. Evaluation on CR viewing angle: A.

### 5. Examples 15 to 19

A surface of a commercially available norbornene polymer film “ZEONOR ZF14-060” (from Optes) was subjected to corona discharge treatment with a solid state corona discharger 6 KVA (from Pillar) to give Film 15. Film 15 had a thickness of 60 μm. Film 15 had an Re (550) of 2 nm and an Rth (550) of 3 nm.

A surface of a commercially available cycloolefin polymer film “ARTON FLZR50” (from JSR Corp.) was subjected to corona discharge treatment as in Film 15 to give Film 16. Film 16 had a thickness of 50 μm. Film 16 had an Re (550) of 2 nm and an Rth (550) of 2 nm.

A stretched film (protective film A) was prepared in accordance with the description in paragraphs [0223] to [0226] of JP-A-2007-127893. An adhesive-layer coating composition P-2 was prepared in accordance with the description in paragraph [0232] of JP-A-2007-127893, and the composition was applied onto the surface of the stretched film in accordance with the description in paragraph thereof to form the adhesive layer to give Film 17. Film 17 had a thickness of 31 μm. Film 17 had an Re (550) of 1 nm and an Rth (550) of 1 nm.

A propylene/ethylene random copolymer containing approximately 5 mass % of ethylene unit (Sumitomo Noblen W151, from Sumitomo Chemical Co., Ltd.) was extruded from a uniaxial melt extruder having a T-die at a melt temperature of 260° C. to yield a primary film. The two sides of the primary film were then subjected to corona discharge treatment to give Film 18. Film 18 had a thickness of 81 μm. Film 18 had an Re (550) of 7 nm and an Rth (550) of 28 nm.

Polyethylene terephthalate (PET) was synthesized in a usual manner and processed into chips. The PET chips were then dried into a water content of 50 ppm or less in a paddle dryer, and then was melted in an extruder while the temperature of the heater was set to 280 to 300° C. The melted polyester resin was discharged from a die onto an electrostatically charged chiller roll to yield an amorphous base. The amorphous base was stretched into a stretching ratio of 3.3 in a base flow direction, and was then stretched into a stretching ratio of 3.9 in a width direction to give Film 19. Film 19 had a thickness of 78 μm. Film 19 had an Re (550) of 1400 nm and an Rth (550) of 7000 nm.

Liquid crystal displays (Examples 15 to 19) were produced as in Example 1 except that the outer protective films (on the viewing side and the BL side) were changed from Film 5 to Films 15, 16, 17, 18, and 19, respectively, and display performance of each liquid crystal display was evaluated as in Example 1. The liquid crystal displays of Examples 15 to 19 produced using Films 15, 16, 17, 18, and 19 exhibited reduced frame-like light leakage and improved display characteristics as in Example 1.

### (Evaluation on Light Leakage at High Humidity Condition)

The liquid crystal display of Example 1 and the liquid crystal displays of Examples 15 to 19 produced using Films 15, 16, 17, 18, and 19 were held at 60° C. and 90% RH for 100 hr in a constant temperature and humidity room, and were then taken out. The liquid crystal displays were then turned into an entirely black display mode and visually observed in a dark room to evaluate light leakage in accordance with the following criterion.

Good: substantially no light leakage was observed (practically no problem).

Allowable: some light leakage was observed though it was practically not problematic.

Although the liquid crystal display of Example 1 was evaluated as “Allowable”, the liquid crystal displays of Examples 15 to 19 were each evaluated as “Good”, showing high moisture resistance.

The present disclosure relates to the subject matter contained in Japanese Patent Application No. 140455/2010, filed on Jun. 21, 2010, which is expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A twisted-alignment-mode liquid crystal display comprising:
a pair of polarizers disposed such that the polarization axes are orthogonal to each other;
a twisted-alignment-mode liquid crystal cell disposed between the polarizers; and
a low-substitution layer comprising cellulose acylate satisfying Formula (1) as a main component,
2.0<Z1<2.7, (1)
where Z1 represents the total degree of substitution of acyl groups of the cellulose acylate in the low-substitution layer.

2. The liquid crystal display according to claim 1, wherein the low-substitution layers are each disposed between the pair of polarizers and the twisted-alignment-mode liquid crystal cell.

3. The liquid crystal display according to claim 2, wherein the low-substitution layer has a retardation in-plane Re (550) of −50 to 150 nm and a retardation along the thickness direction Rth (550) of −50 to 200 nm at a wavelength of 550 nm.

4. The liquid crystal display according to claim 1, wherein the low-substitution layers are each provided on an outer surface of each of the pair of polarizers.

5. The liquid crystal display according to claim 1,
wherein the low-substitution layers are each disposed on an outer surface of each of the pair of polarizers, and are not disposed between each of the pair of polarizers and the twisted-alignment-mode liquid crystal cell, and
the liquid crystal display comprises optically anisotropic layers between each of the pair of polarizers and the twisted-alignment-mode liquid crystal cell, the optically anisotropic layers comprising liquid crystal compounds which are fixed to be in a state of hybrid alignment.

6. The liquid crystal display according to claim 2, wherein the low-substitution layer has a thickness of 30 to 80 μm.

7. The liquid crystal display according to claim 2, wherein the low-substitution layer further comprises a non-phosphate ester compound.

8. The liquid crystal display according to claim 2, which comprises a high-substitution layer disposed on at least one surface of the low-substitution layers, and the high-substitution layer comprising cellulose acylate satisfying Formula (2) as a main component,
2.7≦Z2, (2)
where Z2 represents the total degree of substitution of acyl groups of the cellulose acylate in the high-substitution layer.

9. The liquid crystal display according to claim 8, wherein the low-substitution layer and the high-substitution layer are laminated by co-casting.

10. The liquid crystal display according to claim 8, wherein the high-substitution layer comprises a non-phosphate ester compound as an additive, and
a proportion (parts by mass) of the additive to the cellulose acylate contained in the high-substitution layer is smaller than a proportion (parts by mass) of the additive to the cellulose acylate contained in the low-substitution layer.

11. The liquid crystal display according to claim 7, wherein the non-phosphate ester compound is a polyester compound having an aromatic ring.

12. The liquid crystal display according to claim 2, wherein the cellulose acylate contained in the low-substitution layer satisfies Formulas (3) to (5):
1.0<X1<2.7, Formula (3):
0≦Y1<1.5, Formula (4):
X1+Y1=Z1, Formula (5):
where X1 represents the degree of substitution of acetyl groups of the cellulose acylate in the low-substitution layer, Y1 represents the total degree of substitution of acyl groups having three or more carbon atoms of the cellulose acylate in the low-substitution layer, and Z1 represents the total degree of substitution of acyl groups of the cellulose acylate in the low-substitution layer.

13. The liquid crystal display according to claim 8, wherein the cellulose acylate contained in the high-substitution layer satisfies Formulas (6) to (8):
1.2<X2<3.0, Formula (6):
0≦Y2<1.5, Formula (7):
X2+Y2=Z2, Formula (8):
where X2 represents the degree of substitution of acetyl groups of the cellulose acylate in the high-substitution layer, Y2 represents the total degree of substitution of acyl groups having three or more carbon atoms of the cellulose acylate in the high-substitution layer, and Z2 represents the total degree of substitution of acyl groups of the cellulose acylate in the high-substitution layer.

14. The liquid crystal display according to claim 1, wherein the acyl groups of the cellulose acylate contained in the low-substitution layer and/or the high-substitution layer has a carbon number of 2 to 4.

15. The liquid crystal display according to claim 1, wherein the cellulose acylate contained in the low-substitution layer and/or the high-substitution layer is cellulose acetate.

16. The liquid crystal display according to claim 2, which comprises a film on an outer surface of at least one of the pair of polarizers, the film comprising at least one selected from cyclic olefin resin, polyolefin resin, polyester resin, polycarbonate resin, acrylate rein, and cellulose acylate resin.

17. The liquid crystal display according to claim 1, wherein the low-substitution layers are each disposed between the pair of polarizers and the twisted-alignment-mode liquid crystal cell, the low-substitution layer has a retardation in-plane Re (550) of −50 to 150 nm and a retardation along the thickness direction Rth (550) of −50 to 200 nm at a wavelength of 550 nm, and the low-substitution layers are each provided on an outer surface of each of the pair of polarizers.

18. The liquid crystal display according to claim 1, wherein the low-substitution layers are each disposed on an outer surface of each of the pair of polarizers, and are not disposed between each of the pair of polarizers and the twisted-alignment-mode liquid crystal cell, the liquid crystal display comprises optically anisotropic layers between each of the pair of polarizers and the twisted-alignment-mode liquid crystal cell, the optically anisotropic layers comprising liquid crystal compounds which are fixed to be in a state of hybrid alignment, the low-substitution layer has a thickness of 30 to 80 μm, and the low-substitution layer further comprises a non-phosphate ester compound.

19. The liquid crystal display according to claim 1, wherein the low-substitution layers are each disposed on an outer surface of each of the pair of polarizers, and are not disposed between each of the pair of polarizers and the twisted-alignment-mode liquid crystal cell, the liquid crystal display comprises optically anisotropic layers between each of the pair of polarizers and the twisted-alignment-mode liquid crystal cell, the optically anisotropic layers comprising liquid crystal compounds which are fixed to be in a state of hybrid alignment, the low-substitution layer further comprises a non-phosphate ester compound, the liquid crystal display comprises a high-substitution layer disposed on at least one surface of the low-substitution layers, and the high-substitution layer comprising cellulose acylate satisfying Formula (2) as a main component,
2.7≦Z2, (2)
where Z2 represents the total degree of substitution of acyl groups of the cellulose acylate in the high-substitution layer, and the high-substitution layer comprises a non-phosphate ester compound as an additive, and a proportion (parts by mass) of the additive to the cellulose acylate contained in the high-substitution layer is smaller than a proportion (parts by mass) of the additive to the cellulose acylate contained in the low-substitution layer.

20. The liquid crystal display according to claim 2, wherein the low-substitution layers are each disposed between the pair of polarizers and the twisted-alignment-mode liquid crystal cell, the low-substitution layer further comprises a non-phosphate ester compound, comprises a high-substitution layer disposed on at least one surface of the low-substitution layers, and the high-substitution layer comprising cellulose acylate satisfying Formula (2) as a main component,
2.7≦Z2, (2)
where Z2 represents the total degree of substitution of acyl groups of the cellulose acylate in the high-substitution layer, and the high-substitution layer comprises a non-phosphate ester compound as an additive, and a proportion (parts by mass) of the additive to the cellulose acylate contained in the high-substitution layer is smaller than a proportion (parts by mass) of the additive to the cellulose acylate contained in the low-substitution layer.
